(19) United States
(12) Patent Application Publication
(10) Pub. No.: US 2026/0125518 A1
(43) Pub. Date: May 7, 2026

(54) Articles of Manufacture Comprising Nanocellulose Elements

(71) Applicant: Soane Materials LLC, Miami, FL (US)

(72) Inventors: David S. SOANE, Coral Gables, FL (US); Lauren G. DUKE, Miami, FL (US); Delilah M. LUBARSKY, Miami, FL (US); Sydney Greenough HIGGINS, Miami, FL (US)

(21) Appl. No.: 19/350,599

(22) Filed: Oct. 6, 2025

Related U.S. Application Data
(63) Continuation of application No. PCT/US2024/023776, filed on Apr. 10, 2024.
(60) Provisional application No. 63/458,269, filed on Apr. 10, 2023.

(51) Int. Cl. C08J 3/09; B29C 48/00; B29K 1/00; B29L 31/00; C08K 3/26; C08K 5/09; C08K 5/11

(52) U.S. Cl. CPC C08J 3/095; B29C 48/022; C08K 3/26; C08K 5/09; C08K 5/11; B29K 2001/00; B29L 2031/712; C08J 2301/02; C08J 2301/14; C08J 2401/26; C08J 2493/04; C08J 2497/02; C08K 2003/265

(57) ABSTRACT

The invention includes simple NCE-based materials comprising a simple NCE-based matrix, wherein the simple NCE-based matrix comprises a population of redispersible NCEs treated with a drying/dispersal additive; wherein the matrix provides an architectural framework for the simple NCE-based material; and wherein the simple NCE-based material comprises a barrier formulation. The invention also includes composite NCE-containing materials comprising a composite NCE-containing matrix, wherein the composite NCE-containing matrix comprises a population of redispersible NCEs treated with a drying/dispersal additive and an existing matrix; wherein the redispersible NCEs are integrated into the existing matrix, and wherein the existing matrix provides an architectural framework for the composite NCE-containing material; and wherein the composite NCE-containing material comprises a barrier formulation. The invention further includes plastic substrates comprising the foregoing NCE-containing material, articles of manufacture, and methods for manufacturing.

### RELATED APPLICATIONS

This application is a continuation of International Application No. PCT/US24/23776, which designated the United States and was filed on Apr. 10, 2024, published in English, which claims the benefit of U.S. Provisional Application 63/458,269, filed Apr. 10, 2023. The entire contents of the above applications are incorporated by reference herein.

### FIELD OF THE INVENTION

This application relates to formulations comprising nanocellulosic materials for use in synthetic or natural bioplastic products.

### BACKGROUND OF THE INVENTION

Synthetic plastics are materials made from long polymeric chains, having chemical and physical properties determined by the type of monomers involved in the polymerization process, how they are joined to each other in the polymer's backbone, and what side chains they possess. The majority of plastics have carbon-based backbones, with or without the incorporation of heteroatoms. Synthetic (“man-made”) plastics are formed from chemical reactions such as condensation, addition, and cross-linking. Representative plastic categories include acrylics, polyesters, polyurethanes, halogenated polymers, and bioplastics. This last category, bioplastics, refers to those synthetic plastics formed from bio-derived monomers such as proteins, polysaccharides, and sugar derivatives. The vast majority of synthetic plastics, however, are petroleum-based polymers, formed from petrochemical sources.

Approximately 400 million metric tonnes of synthetic plastics were produced in 2021. Six major polymer types, all derived from petrochemicals, are responsible for about 70% of global plastic production: polyethylene terephthalate (PET), high-density polyethylene (HDPE), low-density polyethylene (LDPE), polyvinyl chloride (PVC), polypropylene (PP), and polystyrene (PS). If current trends continue with increasing demand for plastics and expansion of production capabilities, it is estimated that the annual global plastic production will exceed 1.1 billion tonnes.

The ubiquity of synthetic plastics presents two major environmental challenges. First, they are overwhelmingly made from petrochemical raw materials and require significant energy input for their production, typically associated with the generation of greenhouse gases. Second, conventional synthetic plastics are resistant to degradation, posing formidable obstacles for effective disposal and often persisting in the environment for centuries. While recycling can recover certain components of plastic waste materials, it is expensive, complicated, and thus has been poorly adopted: through 2015, 6.3 billion tonnes of plastic waste have been produced, only 9% of which was recycled, with another 79% being deposited in landfills or being discarded in the environment (including oceans), and another 12% being incinerated, with the consequent release of greenhouse gases and potentially toxic fumes. Despite the environmental consequences associated with synthetic plastics, they have become omnipresent in commerce due in part to their very durability. Because they do not break down, they can be used to form articles that are intended to be nearly permanent, sturdy, and resilient. Their other properties, such as flexibility, formability (plasticity), low costs for production, and light weight, have added to their attractiveness.

Concerns about the environmental impact of discarded and decomposing plastic articles have spurred manufacturers to consider bio-based alternatives. Materials composed in whole or in significant part of biological products or renewable agricultural materials or forestry materials, have been designated as “bio-based” by the USDA. Biopolymers derived from bio-based materials can be used to form bioplastic materials that offer alternatives to conventional, petroleum-derived plastics.

Biopolymers can be produced by biological systems (microorganisms, plants, animals) or chemically synthesized from biological materials such as proteins, starches, and sugars. The primary sources of biopolymers are renewable, such as agricultural feedstocks or waste products. Many biopolymers are biodegradable, which means that they are capable of decomposing into carbon dioxide, water, and other organic compounds via the enzymatic actions of microorganisms. Those bio-based plastics made from precursors such as such as polylactic acid (PLA), polyhydroxyalkanoates (PHAs), and cellulose are typically considered biodegradable, in that they can be decomposed in the environment by microorganisms under certain circumstances (such as, for example, high heat and long duration for PLA). Certain biodegradable materials are further deemed “compostable,” meaning that they can be degraded by microorganisms to form nutrient-rich organic material that is able to enrich the soil, yielding final products that are similar to those produced during natural composting.

While these bio-based plastic alternatives, for example polylactic acid plastics, starch-derived plastics or cellulose-based plastics, are of great interest as substrates for manufacturing plastic materials, their use in common consumer applications, e.g., as durable formed articles, containers and packaging, remains limited, in part due to performance limitations. These materials tend to be hydrophilic and/or lipophilic, having a high affinity for water and/or fats. Thus, these materials can become soggy or impregnated with grease, which makes them unsuitable as containers for foodstuffs and for other water- or oil-laden products. As water or oil penetrate the durable articles, they begin to solvate the containers or packaging materials, affecting their mechanical properties so that they are weakened structurally and predisposed to failure. These limitations of bio-based plastics have been resolved in many cases by coating the bioplastic materials with substances having strong hydrophobic and oleophobic properties, typically petroleum-derived organic substances such as polyethylene, polyethyleneimine, PVC, or fluorocarbons, materials that have a well-recognized impact on the environment. Furthermore, while such coatings improve the water and oil resistance in bio-based materials, such substances can still lack rigidity and mechanical strength.

To address these limitations, manufacturers have added inorganic and organic materials as particulate or fiber fillers to bio-based formulations in order to improve their mechanical properties and streamline their processing. Compared to those materials using inorganic fillers, alternative bioplastics that incorporate natural particles or fibers offer advantages of renewability, high strength, relatively easy processing, and other desirable properties. Nanoscale and microscale cellulosic fibers, such as nanofibrillated celluloses (NFCs), microfibrillated celluloses (MFCs), nanocrystalline celluloses (NCCs) and microcrystalline celluloses (MCCs) are particularly attractive fillers for improving strength. While these nanoscale and microscale cellulose fibers and crystals (collectively termed “nanocellulose elements,” “NC elements,” or “NCEs”) hold promise for use in biopolymeric products, there are restrictions. First of all, the NCE fibers themselves are hydrophilic, and thus do not contribute to the water resistance of a formed product. Water-repellent treatments are thus still necessary for articles that contain NCEs. More importantly, the NCEs need to be transported to where they will be used in highly diluted suspensions (<1-10 wt %) to prevent them from becoming entangled with each other. This entangling can lead to their consolidation into a dense, viscous mass that resists redispersion; if this tight network of aggregated cellulosic elements is further dewatered, it solidifies further, a process termed hornification. With complete drying of the NCE suspension, a solid bricklike mass is formed that is substantially undispersable. Therefore, in order to maintain a NCE suspension in a usable state so that the properties of the NCEs it contains are accessible for use in other materials, it must be maintained in a highly diluted form.

Despite a decade-long series of academic and industrial efforts, success in low-cost and effective drying and redispersion of NCEs has eluded commercial nanocellulose producers. The twin challenges of (a) drying or concentrating the aqueous media in which the NCEs are suspended and (b) subsequently redispersing them are caused by two factors: (1) the propensity of cellulose polymers in the NCEs to form hydrogen bonds with one another, adhering adjacent cellulose elements into irreversible aggregates comprised of an assemblage of particles durably attached to each other that resist redispersion; and (2) the huge surface area per unit weight associated with the size and morphology of the NCE, greatly increasing exposure of the NCE surfaces to each other and exacerbating adhesion due to hydrogen bonding. These two factors combine to produce the hornification associated with concentrated and dried NCE suspensions. The tendency towards hornification in NCE suspensions requires that these substances be transported in a high volume of water, adding significantly to the costs associated with transporting and using them. While drying techniques such as freeze drying, spray drying, supercritical fluid drying and atomization, and the like, have been investigated by researchers, they have at best yielded small samples of redispersed NC elements, using processes whose high cost, energy requirements, and need for specialized equipment preclude their widespread adoption. This resistance to redispersion has impeded the adoption of NCEs as an additive for other bio-based materials.

There remains a need in the art, therefore, for methods and formulations that provide bioplastics with a satisfactory degree of mechanical strength and water/oil resistance, so that they can offer commercially viable alternatives to petroleum-derived plastics for articles of manufacture. To the extent that NCEs are to be integrated into bio-based materials for such articles, there is a need to allow their commercial implementation at low cost, without excessive energy requirements, and without need for specialized equipment. To accomplish these latter goals, there remains an unmet need to render nanocellulose-containing formulations redispersible and resistant to hornification, so that these formulations can be transported economically and introduced into bio-based composites efficiently and cost-effectively.

### SUMMARY OF THE INVENTION

Disclosed herein, in embodiments, are simple NCE-based materials comprising a simple NCE-based matrix, wherein the simple NCE-based matrix comprises a population of redispersed NCEs, and wherein the simple NCE-based matrix provides an architectural framework for the simple NCE-based material. In embodiments, the simple NCE-based material comprises a plurality of submatrices. In embodiments, a pulp or a pulp-based substance is integrated into the simple NCE-based matrix; the simple NCE-based matrix can be pulp-dominant. In embodiments, the simple NCE-based matrix further comprises a reinforcement agent or a barrier formulation. In embodiments, the matrix comprises a reinforcement agent, which can comprise an additional amount of NCEs. In embodiments, the matrix comprises a barrier formulation that produces oleophobicity, which can comprise methylcellulose. In other embodiments, the matrix comprises a barrier formulation that produces hydrophobicity, which can comprise a resin acid or a combination of resin acids. Also disclosed herein are articles of manufacture comprising the simple NCE-based material described above. In embodiments, the article of manufacture further comprises a barrier formulation. In embodiments, the article is shaped into a formed article, which can be shaped as a container.

Also disclosed herein are methods of manufacturing a simple NCE-based material, comprising (a) providing a redispersed suspension comprising redispersed NC elements, wherein the redispersed suspension is produced by the substeps of (i) providing an initial NCE suspension comprising NC elements suspended in a liquid or other fluid medium; (ii) adding a drying/dispersal additive to the initial NCE suspension to form a suspension of redispersible NCEs; (iii) drying the suspension of redispersible NCEs to produce a dried material comprising the redispersible NCEs; and (iv) suspending the dried material in a resuspending fluid to produce the redispersed suspension; (b) drying or concentrating the redispersed suspension to produce a simple NCE-based matrix, wherein the simple NCE-based matrix provides an architectural framework for the simple NCE-based material; and (c) adding an additive substance before or after the step of drying or concentrating, thereby producing the simple NCE-based material. In embodiments, the simple NCE-based matrix comprises a plurality of submatrices. In embodiments, the additive substance is a bulking agent, which can comprise pulp or a pulp-based material. In embodiments, the additive substance is a barrier formulation that produces olcophobicity, and which can comprise methylcellulose. In embodiments, the additive substance is a barrier formulation that produces hydrophobicity, which can comprise a resin acid or a combination of resin acids. In embodiments, the additive substance is an appearance modifying agent such as a pigment.

Further disclosed herein, in embodiments, are composite NCE-containing materials comprising a composite NCE-containing matrices, wherein the composite NCE-containing matrix comprises a population of additive NCEs and an existing matrix, wherein the additive NCEs are integrated into the existing matrix, and wherein the existing matrix provides an architectural framework for the composite NCE-containing material. In embodiments, the existing matrix is bio-based. In embodiments, the composite NCE-containing material further comprises one or more additive substances, wherein each additive substance is selected from the group consisting of reinforcement agents, barrier formulations, and bulking agents. Also disclosed herein are articles of manufacture comprising the composite NCE-containing material described above. The article of manufacture can be selected from the group consisting of transaction cards, containers for liquids, packaging materials for consumer goods, thin films and sheets, and hollow cylinders for flexible tubing. In addition, disclosed herein are methods of manufacturing a composite NCE-containing material, comprising providing a population of additive NCEs and integrating the population into an existing matrix, thereby forming a composite NCE-containing matrix; and adding an additive substance to the composite NCE-containing matrix, thereby producing the composite NCE-containing material.

In yet other embodiments, simple NCE-based materials comprising a simple NCE-based matrix are disclosed herein, wherein the simple NCE-based matrix comprises a population of redispersible NCEs treated with a drying/dispersal additive comprising a lower critical solution temperature (LCST) polymer; wherein the simple NCE-based matrix provides an architectural framework for the simple NCE-based material; and wherein the simple NCE-based material comprises a barrier formulation or a barrier substance. In embodiments, the barrier formulation comprises a substance selected from the group consisting of cellulosic polymers, lipids, proteins, fillers, fatty acids, a resin acid, and combinations of resin acids. In certain aspects, the NCE-based material comprises a barrier substance and the barrier substance is selected from the group consisting of cellulosic polymers, lipids, proteins, fillers, fatty acids, a resin acid, and combinations of resin acids. In embodiments, the barrier formulation comprises a resin acid or combination of resin acids. In certain embodiments, the barrier formulation comprises an oleophobic substance selected from the group consisting of MC, HPMC, CMC, NaCMC, CA. CAB, chitosan, rosin, lignin, pea protein, and zein; in other embodiments, the barrier formulation comprises a hydrophobic substance selected from the group consisting of MC, CA. CAB, chitosan, rosin, hydrophobized starch, lignin, pea protein, and zein. In certain additional embodiments, the barrier substance is an oleophobic substance selected from the group consisting of MC, HPMC, CMC, NaCMC, CA, CAB, chitosan, rosin, lignin, and a vegetable protein; in other embodiments, the barrier substance is a hydrophobic substance selected from the group consisting of MC, CA, CAB, chitosan, rosin, hydrophobized starch, lignin, and a vegetable protein. In embodiments, the NCE-based material further comprises one or more additive substances; in certain aspects the one or more additive substance is selected from a bulking agent, a reinforcement agent, or an appearance-modifying agent, or a combination thereof. In certain aspects, the one or more additive substances is the bulking agent, which can be comprise pulp or a pulp-based substance; in embodiments, the simple NCE-based matrix is pulp-dominant. In embodiments, the bulking agent comprises filler particles, which can comprise plant-derived organic materials. The one or more additive substances can be a reinforcement agent, which can comprise an additional amount of NCEs. In addition, plastic substrates comprising these simple NCE-based materials are disclosed herein, as are articles of manufacture comprising such plastic substrates shaped into a formed article, such as a container, or a food product container.

Also disclosed herein, in embodiments, are methods of manufacturing a plastic article comprising a simple NCE-based material in a pliable state, comprising (a) producing a simple NCE-based material comprising redispersible NC elements, wherein the simple NCE-based material is produced by the substeps of: (i) providing an initial suspension comprising NC elements suspended in a fluid medium; (ii) combining a drying/dispersal additive with the initial suspension to form a pliable suspension of redispersible NCEs; for example, the drying/dispersal additive comprises an LCST polymer; and (iii) adding an additive substance to the pliable suspension of redispersible NCEs while retaining pliability thereof, thereby forming the simple NCE-based material in a pliable state; and (b) forming or shaping the simple NCE-based material in the pliable state into a desired configuration, thereby manufacturing the plastic article. The additive substance can be selected from the group consisting of reinforcement agents, barrier formulations, barrier substances, and bulking agents. In embodiments, the step of forming or shaping comprises extrusion.

Further disclosed herein, in embodiments, are composite NCE-containing materials comprising a composite NCE-containing matrix, wherein the composite NCE-containing matrix comprises a population of redispersible NCEs treated with a drying/dispersal additive comprising a lower critical solution temperature (LCST) polymer, and an existing matrix; wherein the redispersible NCEs are integrated into the existing matrix, and wherein the existing matrix provides an architectural framework for the composite NCE-containing material; and wherein the composite NCE-containing materials comprise a barrier formulation or a barrier substance. In embodiments, the existing matrix comprises a bio-based polymer, which can comprise a cellulose derivative, which can be a polyhydroxyalkanoate. In embodiments, the existing matrix comprises a petroleum-derived polymer, which can be derived from a plastic material that has been recycled. In embodiments, the barrier formulation comprises a substance selected from the group consisting of cellulosic polymers, lipids, proteins, fillers, fatty acids, a resin acid, and combinations of resin acids. In certain aspects, the NCE-containing material comprises a barrier substance and the barrier substance is selected from the group consisting of cellulosic polymers, lipids, proteins, fillers, fatty acids, a resin acid, and combinations of resin acids. In certain embodiments, the barrier formulation comprises an olcophobic substance selected from the group consisting of MC. HPMC. CMC, NaCMC, CA, CAB, chitosan, rosin, lignin, and a vegetable protein; in other embodiments, the barrier formulation comprises a hydrophobic substance selected from the group consisting of MC, CA, CAB, chitosan, rosin, hydrophobized starch, lignin, and a vegetable protein. In certain additional embodiments, the barrier substance is an oleophobic substance selected from the group consisting of MC. HPMC. CMC, NaCMC, CA, CAB, chitosan, rosin, lignin, and a vegetable protein; in other embodiments, the barrier substance is a hydrophobic substance selected from the group consisting of MC, CA, CAB, chitosan, rosin, hydrophobized starch, lignin, and a vegetable protein. In certain embodiments, the barrier formulation comprises a resin acid or the combination of resin acids. In embodiments, NCE-containing material further comprises one or more additive substances selected from a bulking agent, a reinforcement agent, or an appearance-modifying agent. In certain embodiments, the one or more additive substances produce in the composite NCE-containing material a property selected from the group consisting of structural strength, resilience, elasticity, water resistance, and oil and grease resistance. In addition, plastic substrates comprising these composite NCE-containing materials are disclosed herein, as are articles of manufacture comprising such plastic substrates shaped into formed articles, such as transaction cards, containers for liquids, containers for food products, food utensils, packaging materials for consumer goods, thin films and sheets, and hollow cylinders for flexible tubing.

Also disclosed herein, in embodiments, are methods of manufacturing a plastic article comprising a composite NCE-containing material in a pliable state, comprising: (a) producing a composite NCE-containing material comprising redispersible NC elements, wherein the composite NCE-containing material is produced by the substeps of (i) providing an initial suspension comprising NC elements suspended in a fluid medium; (ii) combining a drying/dispersal additive with the initial suspension to form a pliable suspension of redispersible NCEs; for example, the drying/dispersal additive comprises an LCST polymer; (iii) integrating the pliable suspension into an existing matrix, thereby forming a composite NCE-containing matrix in the pliable state; and (iv) adding an additive substance to, and retaining pliability of, at least one of the initial suspension, the pliable suspension, the existing matrix, and the composite NCE-containing matrix, thereby forming the composite NCE-containing material in the pliable state; and (b) forming or shaping the composite NCE-containing material in the pliable state into a desired configuration, thereby manufacturing the formed article. The additive substance can be selected from the group consisting of reinforcement agents, barrier formulations, barrier substances, and bulking agents. In embodiments, the step of forming or shaping comprises extrusion.

### BRIEF DESCRIPTION OF THE FIGURES

FIG. 1 is a block diagram showing a process for producing matrices comprising redispersed nanocellulose elements.

FIG. 2 is a block diagram showing a process for producing matrices comprising redispersed nanocellulose elements.

FIG. 3 is a block diagram showing a process for producing matrices comprising redispersed nanocellulose elements.

### DETAILED DESCRIPTION OF THE INVENTION

### 1. Components of Redispersible Nanocellulose Elements Formulations

a. Redispersible Nanocellulose Elements Generally

It has been unexpectedly discovered that nanocellulose elements (NCEs) can be treated so that they can be redispersed in formulations for producing useful articles of manufacture, using formulations and methods as set forth herein and as set forth in U.S. Pat. App. Publication No. 20220412010A1 (U.S. patent application Ser. No. 17/834,521 filed Jun. 7, 2022; the '521 Application), the contents of which are incorporated by reference herein in their entirety. Using these inventive methods, formulations containing NCEs can be prepared that can be concentrated or dried and then redispersed without hornification. Such formulations comprising redispersed NCEs can then be employed for the manufacture of useful articles. The formulations themselves can be dried and formed to produce articles of manufacture, or the formulations can be integrated into existing matrices to form composites having improved properties vs the existing matrix itself or that have additional properties not present in the existing matrix.

Substrates suitable for treatment with the systems and methods disclosed herein (i.e., NFCs and MFCs, and NCCs and MCCs, collectively NCEs) can be derived from all types of cellulosic raw materials, in particular from plant-derived cellulosic raw materials. Plant-derived cellulosic raw materials comprise lignocellulosic materials: lignocellulosic materials are comprised of cellulose polymers bound together with varying amounts of lignin. Lignocellulosic materials of all kinds are suitable for producing NCEs or other lignocellulosic materials such as pulp. Plants having use as lignocellulosic materials can be woody (such as trees, with firm stems, and with multiyear growth cycles) or non-woody, having weak stems and annual or limited multiyear growth cycles. Lignocellulosic materials can include specialty-purpose crops such as switchgrass and elephant grass cultivated for uses such as biofuels, capable of multiple harvests. Materials useful for producing pulp can be derived, without limitation, from industries such as agriculture (e.g., corn stover and corncobs, sugarcane bagasse, straw, oil palm empty fruit bunch, pineapple leaf, apple stem, coir fiber, mulberry bark, rice hulls, bean hulls, soybean hulls (or “soyhulls”), cotton linters, blue agave waste, North African glass, banana pseudo stem residue, groundnut shells, pistachio nut shells, grape pomace, shea nut shell, passion fruit peels, fique fiber waste, sago seed shells, kelp waste, juncus plant stems, and the like), or forestry (saw mill and paper mill discards).

In embodiments, NCEs are conventionally produced from precursor lignocellulosic materials or other plant-derived cellulosic raw materials by a series of mechanical and/or chemical procedures performed in an aqueous medium, wherein the aqueous suspension loosens cellulose's interfibrillar hydrogen bonding to facilitate delamination, resulting in the formation of the NCEs. NFCs and MFCs are extracted from plant matter by different techniques from each other, so that their morphologies and properties are different. NFCs and MFCs can be distinguished from each other based on their size and shape: cellulose nanofibers are much smaller in diameter than cellulose microfibers and can be straight and rod-like, while cellulose microfibers are larger in diameter, more flexible, and more varied and irregular in appearance. While the literature cites a range of dimensions for NFCs and MFCs, NFCs fibers are nanoscale (for example, having a diameter between 4-20 nm), while MFCs can be much larger, though typically still having diameters in the nano-range, for example 20-100 nm or larger. After the NCEs have been formed from the precursor cellulosic material, the NCEs are dispersed in the aqueous medium at a low concentration (<10 wt %) because their high water-absorption capacity and tendency for hydrogen bonding cause them to form a highly viscous suspension even at low solid concentrations due to the hydrogen-bond-driven entangling of the high-aspect-ratio NC elements, as described above.

Additives have been discovered, as described in the '521 Application, that can be used to prepare NCEs so that they are redispersible after being formulated in solutions. Such additives are termed “drying/dispersal additives” herein. Without being bound by theory, these additives function to inhibit or disrupt that hydrogen bonding of the NCEs with each other at specific, usually elevated reaction temperatures, thus preventing consolidation and hornification, while retaining their high intrinsic hydrophilicity that allows facile redispersion in aqueous media. As used herein, the term “redispersion” and its grammatical derivatives and congeners refers to a process by which dried or concentrated NCEs prepared to be redispersible as described herein are suspended in a fluid medium (whether aqueous or non-aqueous), termed a resuspending fluid, so that there is a substantially complete dissolution of the dried or concentrated suspension of NCEs to release its NCE components as resuspended in the resuspending fluid. In embodiments, aqueous resuspending fluids can be used; in other embodiments, non-aqueous resuspending fluids can be used, such as fluids having hydrophobic properties or amphiphilic properties.

As used herein, the term “redispersible” refers to those NCEs that have been treated with a drying/dispersal additive as disclosed herein, which treatment renders the NCEs capable of redispersion. Formulations containing such redispersible NCEs can exist in a liquid, dried, or partially-dried state. In a fully dried or partially dried state, the NCEs in the formulation are capable of redispersion by suspending them in a resuspending fluid. Redispersible NCEs (i.e., NCEs treated with drying/dispersal additives as disclosed herein) can be contained in liquid formulations before they are dried; the presence of the drying/dispersal additives renders such NCEs redispersible so that they can undergo subsequent redispersion if they are dried or concentrated. Redispersible NCEs also exist in liquids formed by adding a resuspending fluid to a dried or concentrated formulation containing the redispersible NCEs; their presence as resuspended in such a liquid demonstrates that they are, in fact, capable of redispersion and are thus redispersible. For the avoidance of doubt, this last group of redispersible NCEs, which are formulated to be redispersible and have been resuspended in a resuspending fluid that renders them in fact redispersed, can also be termed, more specifically, “redispersed NCEs”; all redispersed NFCs are, by definition, redispersible, but not all redispersible NFCs are redispersed.

In embodiments, redispersion results in a suspension of the NCEs so that they are formed as individual NCEs or amorphous coalescences of individual NCEs (either being referred to herein as “resuspended particles”), wherein such resuspended particles have an aspect ratio of greater than 10. In embodiments, the resuspended particles have an aspect ratio between about 10 and about 300, or between about 10 and about 200. In embodiments, the resuspended particles have an aspect ratio between about 50 and about 150. In embodiments, the resuspended particles have an aspect ratio between about 25 and about 75. In other embodiments, the resuspended particles have an aspect ratio between about 75 and about 125.

These formulations and methods include several different categories of drying/dispersal additives: (1) certain temperature-responsive polymers that can introduce spacing between NC elements during drying, thus preventing their clumping; (2) certain volatile small molecules that can create space between NC elements during drying; and (3) certain nonvolatile small or large molecules (“blocking agents”) that hinder hydrogen bonding between or among NC elements during drying. Drying/dispersal additives comprise, without limitation, temperature-responsive polymers, small molecule additives in volatile systems, and blocking agents. All of these materials act to disrupt hydrogen bonding at elevated temperatures or under other circumstances, while creating gaps between or among the NC elements with further drying that will permit subsequent redispersion.

While certain additives (for example, certain LCST polymers, as described below) are suitable for use as single agents for facilitating drying and redispersion, other additives lend themselves for use as adjuvants in combination with a main drying/dispersal additive, either when administered into the initial NC suspension simultaneously with the main additive, or when administered as pre-treatment to the initial NC suspension or any precursor thereof before adding the main additive, or when administered as a post-treatment to the initial NC suspension following the addition of the main drying/dispersal additive.

b. Drying/Dispersal Additives

It is understood that the drying/dispersal additives disclosed herein can be introduced into the initial NCE-containing suspension individually or in combination to improve the drying process for the NCEs and to facilitate their redispersion. Drying/dispersal additives can also be used in combination with other agents that enhance their efficacy, even if those other agents are not effective as drying/dispersal additives when used alone; such agents, used in combination with the drying/dispersal additives to enhance their efficacy, are termed “adjuvants.” It is further understood that one or more of the drying/dispersal additives and/or adjuvants can act together in a synergistic manner. Moreover, combinations of the drying/dispersal additives can be introduced sequentially during the preparation of the initial NC suspension, and/or before, after, or during the processes that are employed to produce the initial NC suspension from a feedstock of cellulosic sources, with or without the addition of adjuvants. For example, non-polymeric additives can be added during the processes that are employed to produce the initial NC suspension from feedstock, but desirably are to be added after chemical pretreatment of the initial NCEs that are derived from the cellulosic or lignocellulosic precursor material.

i. Temperature-Responsive Polymers

In embodiments, certain temperature-responsive polymers can be employed to create space between the NC elements during drying, thereby preventing the NC elements from aggregating during the drying process. By preventing the dense aggregation and consolidation of the NCEs, the temperature-responsive polymer allows them to be redispersed upon contact with the resuspending fluid. Temperature-responsive polymers especially suitable for this purpose are those that exhibit a phenomenon known as LCST (lower critical solution temperature) phase behavior. It is understood that certain LCST polymers are hydrophilic below their LCST transition temperature and become reversibly hydrophobic above their LCST transition temperatures. In other words, below the LCST point the polymer shows high affinity towards water, consistent with its intrinsic molecular hydrophilicity. However, above the LCST point, the polymer repels water and shuns hydrogen bonding. This is evidenced by the observed thermogelation of polymer solutions above this transition temperature. As the polymeric or oligomeric LCST additive self-assembles on the surface of the NC elements (in the form of mono-layer or a few molecular layers), drying of NC elements and the resulting morphology of the NC-containing material the dried state are affected so that the ultimate redispersion of such NCEs is facilitated.

For use in this setting, the LCST polymer can be added to the initial NC suspension at a temperature below the LCST polymer's transition temperature. The initial NC suspension is then heated to effect its drying. As water evaporates from the initial NC suspension during drying, its temperature rises and approaches the boiling point of water, coming to exceed the LCST polymer's transition temperature, at which point the LCST polymer loses its hydrophilic character and becomes hydrophobic. When it becomes hydrophobic, the LCST polymer's behavior changes: at that point it interferes with the hydrogen bonds that would be forming between the NC elements. The hydrophobic nature of the LCST polymer now drives the aggregation or disaggregation of the NC elements, instead of these processes being driven by the interaction of the hydrophilic cellulosic units of the NC elements.

In embodiments, selected LCST polymers can markedly or completely hinder the dense aggregation and consolidation of NC elements upon drying. In embodiments, the ability of selected LCST polymers to disrupt dense aggregation and consolidation of NC elements is independent of equipment selection and manner of drying. For example, the suspension containing the LCST polymer and the NC elements can be left quiescent during drying. A wide range of drying temperatures and pressures can be applied to the initial NC suspension in the presence of selected LCST polymers to accomplish aggregate-free drying. Dried NC materials that incorporate selected LCST polymers as described herein can be readily redispersed in water with gentle agitation or stirring, with minimal or no clotting or residual dense aggregations or consolidations identified in the redispersed suspension. These features allow for a wide latitude in parameters for redispersion and for processing the redispersed material.

In embodiments, the list below offers examples of LCST polymers and their analog short-chain oligomers that can be used as drying/dispersal additives to prevent dense aggregation and consolidation, and thereby to facilitate subsequent redispersion of NC elements.
Methyl cellulose.
Carboxymethyl cellulose
Sodium carboxymethyl cellulose
Hydroxylethyl cellulose
Hydroxypropyl cellulose
Hydroxypropylmethyl cellulose.
Ethylhydroxyethyl cellulose.
Polyvinylcaprolactam
Poly(methyl vinyl ether)
Poly(N-isopropylacrylamide)
Poly(N,N-diethylacrylamide).
Block copolymer of poly(ethylene oxide) and poly(propylene oxide)
Poly(pentapeptide) of elastin

Note that thermogelation temperature of certain of the additives listed above depends on the type and degree of substitution and is tunable by structural design. Advantageously, a selected LCST polymer for use as a drying/dispersion additive can have a transition temperature that is greater than the ambient temperature (for example, >25° C.), so that the polymer remains in solution until the drying step commences.

ii. Volatile Small-Molecule Additive Systems

In embodiments, volatile systems comprising small molecule additives can be employed alone or in combination with other additives to act as drying/dispersal additives by creating space between the NC elements during drying and thereby preventing the NC elements from aggregating during the drying process. The selected small molecule additives for use with volatile systems are miscible with water and have a boiling point higher than that of the co-existing water. A small molecule additive useful in a volatile system is further characterized by its greatly lower hydrogen-bonding tendency compared to water. As the additive-loaded volatile system containing the NCEs and the selected small molecule additive undergoes drying, water molecules evaporate preferentially, leaving the small molecule additive behind due to its higher boiling point and thereby increasing the concentration of the additive in the remaining solution that remains in between adjacent NC elements. In embodiments, the molecular segments of the volatile small molecule additives comprise both polar and non-polar functionalities. Not being bound by theory, it is envisioned that the polar segments are attracted by the cellulosic hydroxy groups while the non-polar segments simultaneously interfere with hydroxy-hydroxy interactions, thus reducing adherence between and among the NC elements. Then, as the temperature in the system rises, the additive evaporates, leaving behind the NC elements surrounded by air and thus separated from each other. The resulting dried material, containing NC elements that are separated from each other by air, can be readily re-dispersed without forming indicia of aggregation or consolidation such as observable clumps/clots or concentration variations. The redispersed suspension comprises resuspended NC particles that are uniform in distribution within the suspension, wherein the NC elements retain their nano-size characteristics and can achieve redispersion with only very mild agitation/stirring.

In embodiments, the lists below offer examples of small molecule additives that can be used as drying/dispersal additives in the aforesaid volatile systems to prevent dense aggregation and consolidation, and thereby to facilitate subsequent redispersion of NC elements. Exemplary additives can be divided into two categories: non-ionic and cationic compounds.

Non-ionic candidates can include, without limitation:
Tri(propylene glycol) butyl ether (TPnB).
Di(propylene glycol) propyl ether (DPnP)
Propylene glycol butyl ether (PnB)
Propylene glycol propyl ether (PnP).
Ethylene glycol monobutyl ether.
Propylene glycol monomethyl ether acetate
Propylene glycol diacetate
Ethylene glycol diacetate
Benzyl alcohol
1-Heptanol
1-Hexanol

Cationic candidates can include, without limitation:
Ethylene diamine.
Diethylene triamine
Tetraethylene pentaamine.
1,3-Pentane diamine
Piperazine
1,2-Cyclohexane diamine
Aniline
Pyridine
Piperazine

In embodiments, the small molecule additives can evaporate completely from the initial NC suspension, just leaving behind the NC elements in suspension or in dried form without additive residue. However, in other embodiments, trace amounts of the small molecule additives can remain. For example, with certain cationic additives, their cationic groups can adhere to cellulose molecules, so that trace amounts of the additive remain adherent to the cellulose after complete drying. For most industrial applications, the trace residues of these additives do not pose a health or environmental problem. However, in embodiments, a biodegradable cationic small molecule such as 1,3-pentane diamine can be selected to avoid such issues.

iii. Blocking Agents

In embodiments, non-volatile small or large molecule additives can be employed themselves, apart from volatile systems as described above, to hinder hydrogen bonding and/or to create space between the NC elements during drying, thereby blocking interactions between the NC elements and thus preventing the NC elements from aggregating during the drying process. In embodiments, surface-functionalized nanoscale particles can be employed in the same manner. Such non-volatile small or large molecule additives and nanoscale particles employed to carry out this blocking function are referred to herein as blocking agents or blockers. As used herein, the term “blocking agent” or “blocker” includes any non-volatile chemical additive or nanoscale particulate material that itself hinders hydrogen bonding or creates spaces among NC elements, whether the substance is interposed between or among NC elements, or whether the substance offers temporary competitive binding sites for the NC elements, or otherwise.

As an example, caffeine and other xanthine derivatives are small-molecule blockers that can be used advantageously to facilitate isolation of NC elements from each other during a drying or concentrating process and their subsequent redispersion. Not being bound by theory, it is envisioned that the aromatic nitrogen atoms in certain purines (such as caffeine and other xanthines or xanthine derivatives) and pyrimidines can become hydrogen-bonded with the hydroxy groups of the cellulose, presenting a flat, relatively non-polar, and molecularly-lubricating and water-screening outer surface to the NCEs, thus hindering adhesion between and among NC elements. Caffeine and other xanthines and xanthine derivatives can typically be used in quantities that do not present health or environmental problems even when used in sufficient dosages to facilitate NC dispersion.

As another example, certain humectant substances can be employed as blocker molecules. Humectants possess multiple hydrophilic sites such as hydroxyls, esters, and ammonium groups that can form hydrogen bonds with the surface of the NC elements, thus screening the interaction of these elements with each other via hydrogen bonding, and thereby impairing dense aggregation and consolidation. Moreover, these hygroscopic substances are biocompatible and are already widely used in the pharmaceutical, cosmetic, and food industries. Exemplary short and long humectant candidates include but are not limited to glycerin, caprylyl glycol, ethylhexylglycerin, tribehenin, hydrolyzed soy protein, various amino acids, propylene glycol, methyl gluceth-20, phenyl trimethicone, hyaluronic acid, sorbitol, and gelatin.

As yet another example, fatty acids can be employed as blockers as well. Fatty acids contain hydrophilic sites and a hydrophobic tail. The hydrophilic site can form hydrogen bonds with the surface of NC elements, thus screening the interaction of these elements with each other via hydrogen bonding, thereby impairing aggregation. Preferably, fatty acids can be selected that do not contain so many hydrophilic sites that excessive hydrogen bonding will occur between NCE particles and the fatty acids. However, in embodiments wherein too many hydrogen sites may cause dense aggregation and consolidation, the hydrophobic tail of the fatty acid blockers can act to physically prevent dense aggregation and consolidation of NC elements by preventing or interfering with hydrogen bonding. In embodiments, the blocking agent can be a fatty acid, such as stearic acid, palmitic acid, myristic acid, lauric acid, capric acid, caprylic acid, caproic acid, and the like. To facilitate dispersion of the fatty acid in aqueous solutions of NC elements, a water-soluble fatty acid can be selected.

### 2. Redispersible and Redispersed Suspensions of NC Elements

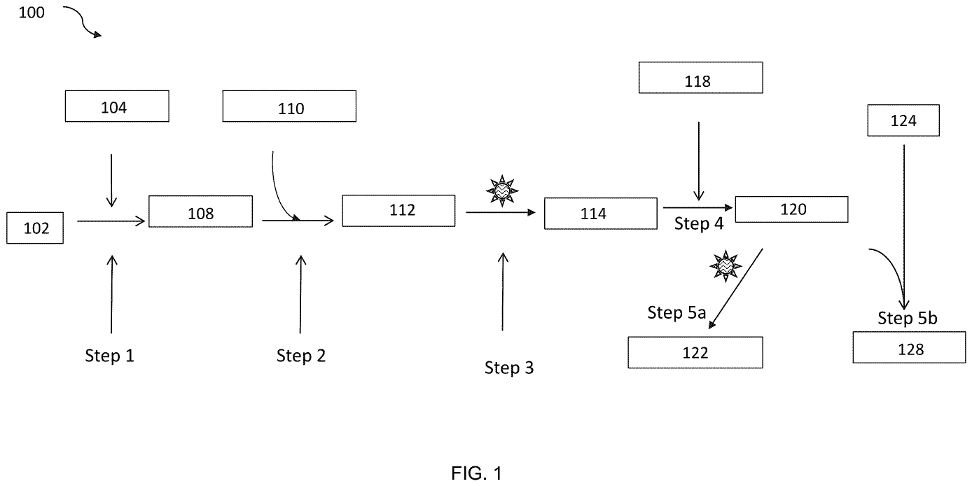

The block diagram of FIG. 1 depicts schematically the processes 100 involved in preparing redispersible suspensions of NC elements that can be further processed to yield redispersed suspensions of NC elements and materials made therefrom. As shown in FIG. 1, the processes 100 for producing a suspension of redispersed NC elements involve four steps.

Step 1 suspends a population of NCEs 102 in a suspension fluid 104 to produce the initial NCE suspension 108. Processes for forming initial NCE suspensions suitable for further processing using the formulations and methods disclosed herein are familiar in the art. To form such a NCE-containing suspension, cellulose sources can be processed using conventional mechanical techniques and optional chemical treatments to extract the component cellulosic nanomaterials (i.e., the NCEs) and retain them as suspended in a liquid or other fluid medium. The NC elements thus extracted form the initial NC suspension, which can be treated to render them redispersible in the next step, using the disclosed formulations and methods.

In Step 2, a drying/dispersal additive 110 as described above is added to the initial NCE suspension 108, to produce a suspension of redispersible NCEs 112. As discussed previously, the drying/dispersal additive 110 allows the NCEs in the initial NCE suspension 108 to be redispersible. The redispersible suspension of NCEs 112 is dried in Step 3, to produce a dried material 114 containing redispersible NCEs. The dried material 114 containing the redispersible NCEs is then either ground/shredded and used as a dry ingredient, or suspended in a resuspending fluid 118 in Step 4, to produce a suspension 120 of the desired concentration of the redispersible NCEs produced as described above; such redispersible NCEs treated by suspension in a resuspending fluid as set forth in Step 4 can also be termed “redispersed NCEs.” In embodiments, the suspension 120 of redispersed NCEs can then be processed by itself, for example by drying or concentrating as shown in Step 5a, to form a simple NCE-based matrix 122 of dried, redispersed NCEs that is formed as a continuous sheet. At a microscopic level, the structure is a three-dimensional, highly porous, and typically forms a largely structurally amorphous network; however, semi-crystalline NCE matrices can be synthesized, if nanocrystalline elements are used and/or crosslinking strategies such as, for example, the grafting and esterification of carboxylic acids onto the surface of NCEs are employed. As used herein, the term “amorphous” refers to any solid formation in which the components are not organized in a definite and repeating lattice pattern. Amorphous structures usually enhance degradability. In addition, additive substances (not shown) can be easily incorporated in the amorphous simple NCE-based matrix 122 to produce advantageous features such as malleability, workability, heat tolerance, strength, or oleophobic or hydrophobic properties.

Pulp-based or pulp-containing additives that do not contain NCEs can also be added, in order to reduce the amount of NCEs that are required to produce desirable properties for the matrix. As used herein, the term “pulp-based” refers to those materials that have been derived from pulp by processing, forming, or treating while retaining pulp or pulp derivatives within their substance.

Pulp is understood to be manufactured from materials containing cellulose or lignocellulosic fibers such as wood, non-wood raw materials, specialty-purpose crops, waste paper, recycled paper, agricultural residues, and the like. Non-wood raw materials such as bagasse, cereal straw, bamboo, reeds, esparto grass, jute, flax, and sisal are familiar in the art as sources of cellulose fibers; certain non-limiting examples of materials containing lignocellulosic fibers are also provided herein. Wood and other plant materials used to make pulp contain three main non-water components: cellulose, lignin, and hemicellulose. The chemical and/or mechanical processes for making pulp aim to break down the bulk structure of the plant material source into constituent fibers, thereby producing the fibrous, cellulose-containing material known in the art as pulp. Pulp can also be formed from previously processed materials such as waste paper or recycled paper or certain fabrics; such materials may lack some or all of the components found in wood or other pulp materials, but can be subjected to chemical or mechanical processes suitable for forming them into pulp.

Pulp and pulp-based materials can be used with the formulations, compositions, and methods disclosed herein, to be formed or shaped as components of or substrates for articles of manufacture in any useful shape, such as sheets, fibers, solid articles, molded articles, etc. Such additives can act as low-cost bulking agents to add volume to the matrix so that a larger amount of simple NCE-based matrix is produced; in such a matrix, the redispersible or redispersed NCEs are added in combination with the bulking agent (for example, conventional pulp or other pulp-based substance) so that the final matrix has the desired mechanical properties.

While NCEs are understood to be additive substances responsible for features of the organization and architecture of the matrix with resulting performance attributes, other additives can be added to the matrix to produce either advantageous features as described above or other desirable properties. For example, appearance-modifying additives such as pigments or other color-producing agents can be added to the matrix, or other additives intended to provide desirable properties, for example, odor-related agents, emollients, cosmetics, pharmaceutical products, medical products, and agricultural active ingredients, fragrances and scents, and the like. Other, related additives can be included in the matrix to allow a particular additive to accomplish its intended purpose. For example, a NCE matrix can include odor-blocking chemicals or natural scents adapted for release in close quarters that have high levels of odoriferant materials, for example in articles such as gym bags, suitcases, etc., or adapted for use in personal articles likely to be odorific (e.g., shoe inserts or liners). A NCE matrix adapted for these purposes can incorporate plasticizers or other additives to tune the release of the anti-odor agents or to adapt their release to certain environmental conditions (for example, shoe liners that emit odor-control substances when in contact with body-temperature feet). Analogously, an NCE-based matrix can be formulated with a deodorant or antiperspirant substances in the matrix interstices, with the NCE-based matrix serving to permit a more durable application of such products to the skin. As further examples, a variety of scents can be employed with the systems disclosed herein. The term “scent” as used herein refers to the variety of odors that can be deliberately incorporated in and delivered by the matrices as described herein. For example, pleasant scents can be employed for cosmetic or aesthetic purposes, or to camouflage unpleasant odors. Scents can be employed for medical, veterinary, or agricultural purposes, to act as insect repellants, pesticides, pheromones, growth hormones, or the like. Scents can be sourced from volatile aromatic compounds, such as essential oils, hydrosols, perfume microcapsules, etc. Exemplary sources can incorporate biological oils and chemical sources suspended in solution for easy application or mixing. Other sources for scents can be aqueous-based, such as hydrosols. Other examples of scent-based technologies based on the formulations disclosed herein include without limitation insecticides for the agricultural sector, perfumes and odor neutralizers for household use, and pet hormones to encourage calm behavior around the home. By controlling the rate of release through careful manipulation of the base technology, the applications can be personalized for various consumer needs, for example, for agricultural products that release pesticides quickly during planting season and more slowly when the plants are fully grown. The technologies disclosed herein can be readily adapted for agricultural purposes, for example with the use of pheromones as the agricultural active ingredients. Pheromones are understood to be secreted or excreted chemicals that trigger a social response in members of the same species. While they may not possess “odors” as the term is commonly understood, pheromone receptors are typically located in the olfactory epithelium or vomeronasal organ, indicating that they are processed by similar pathways as conventional. Pheromones are thus considered odor-related active agents for the purposes of the present disclosure; they are known to be useful in the agricultural industry as pesticides or artificial growth hormones. The foregoing examples are intended to be illustrative and not limiting. Other examples of additive substances that are useful with the matrices disclosed herein can be readily envisioned by those of skill in the art.

Additive substances can become incorporated in or added to the simple NCE-based matrix 122 before, during, or after the processing of Step 5a: the additive substance(s) can be added to the suspension 120 of redispersed NCEs prior to the processing Step 5a, and/or they can be added as the suspension 120 is dried or concentrated, and/or they can be added to the simple NCE-based matrix 122. A material comprising the simple NCE-based matrix 122, wherein the simple NCE matrix 122 provides the architectural framework for the material, and further comprising any additive substances can be termed a “simple NCE-based material.” When the term “matrix” is employed herein, as in “simple NCE-based matrix,” it is understood that the process of matrix-formation described above need not produce a single, continuous simple NCE-based matrix, but can instead produce a plurality of simple NCE-based matrices that are more loosely connected to each other or are discontinuous. If a plurality of simple NCE-based matrices is produced by the processes as disclosed herein, the interrelationship of the matrices thus formed provides organization and architecture that can be carried over into the final simple NCE-based material. In more detail, the NCEs, when redispersed, can form entanglements or attachments with each other that constitute one or more matrices. Physically mixing the liquid formulation comprising the redispersed NCEs can fragment the one or more matrices into smaller ones that associate more loosely with each other. This association of smaller matrices can provide the structural stability that is desirable for the simple NCE-based material. This arrangement is compatible with the addition of pulp or pulp-based substances that can act as bulking agents, fillers, and the like. The architecture of the simple NCE-based matrix allows the pulp or pulp-based material to be integrated into the overall matrix without substantially impairing its strength, stability, and/or durability.

In other embodiments, the suspension 120 can be added to another, existing matrix 124, as shown in Step 5b, to form a composite NCE-containing matrix 128. The redispersed NCEs in the suspension 120 can be termed “additive NCEs” when they are used in Step 5b to be added to the existing matrix 124. In embodiments, the existing matrix 124 provides the architectural framework for the composite NCE-containing matrix, while the NCEs are integrated into the composite NCE-containing matrix 128. An existing matrix 124 can provide an amorphous host matrix, or it can produce a more discernibly ordered pattern of atoms or molecules in a regular lattice-like array, as might be seen in a crystal. In the composite NCE-containing matrix 128, the NCEs become intercalated into the existing matrix 124 to form the composite NCE-containing matrix 128. The more of the additive NCEs that the composite NCE-containing matrix 128 contains, the more the properties of the composite NCE-containing material 128 exhibits properties attributable to the NCEs. For example, a formulation comprising additive NCEs and a pulp-based bulking agent can provide significant strength to a composite NCE-containing matrix 128, while the presence of the pulp-based bulking agent adds volume to the composite NCE-containing matrix 128, potentially making it cheaper to produce. Other properties of the composite NCE-containing matrix 128 can be provided by the existing matrix 124 alone or in interaction with any structural organization or other properties provided by the additive NCEs.

In embodiments, other additive substances can be included in the composite NCE-containing matrix to add or improve desirable features such as malleability, workability, heat tolerance, strength, or olcophobic or hydrophobic properties. Such additive substances can become available for or added to the composite NCE-containing matrix 128 before, during, or after the population of redispersed NCEs from the suspension 120 is added to the existing matrix 124. In embodiments, the existing matrix 124 already includes some or all of the desired additive substances, and their presence carries over into the composite NCE-containing matrix 128. In other embodiments, additive substances are included when the redispersed NCEs and the existing matrix 124 are combined in Step 5b to form the composite NCE-containing matrix 128. In yet other embodiments, additive substances can be introduced into the composite NCE-containing matrix 128 after it is formed. The composite NCE-containing matrix 128 with its included additive substances provides a material that can be further processed, shaped, or otherwise formed into articles of manufacture. A material comprising the composite NCE-containing matrix 128, wherein the composite NCE-containing matrix provides the architectural framework for the material, and further comprising any additive substances can be termed a “composite NCE-containing material.”

Both the simple NCE-based matrix 122 and the composite NCE-containing matrix 128 can be used to provide an architectural framework for materials comprising redispersed NCEs as shown in this Figure, wherein such materials can be formed or shaped to produce articles of manufacture. In other embodiments not depicted in this Figure, a simple NCE-based matrix or a composite NCE-containing matrix can be used to provide an architectural framework for materials comprising redispersible NCEs.

### 3. Redispersible and Redispersed Nanocellulose Elements in Plastic Substrates for Producing Articles of Manufacture

As described above, redispersible or redispersed NC elements produced in accordance with the systems and methods disclosed herein can be included in matrices that are used to form NCE-containing materials, both as components of simple NCE-based materials formed solely or predominately from redispersible or redispersed NCEs without including another existing matrix, and as components of composite NCE-containing materials which comprise a composite NCE-containing matrix having redispersible or redispersed NCEs intercalated into an existing matrix. Both simple NCE-based materials and composite NCE-containing materials can be employed as plastic substrates or as components of plastic substrates that can be formed into other articles of manufacture. As used herein, the term “plastic” refers to a material incorporating a three-dimensional framework (or “matrix”) and retaining pliability, thus yielding a NCE-based or NCE-containing material in a pliable state. Such a plastic material can be formed or shaped from its pliable state into a desired configuration and can further be fixed in the desired configuration so that the configuration is retained for a designated period. The process of shaping or forming the material from its pliable state into the desired configuration can be accomplished by many techniques familiar in the art, such as extrusion, calendaring, injection molding, thermoforming, blow molding, and the like. The process of fixing the material in the desired configuration can likewise be accomplished by many techniques familiar in the art, such as heating, applying prolonged pressure, and/or incorporating additives that permit hardening, fixation, or curing. The designated period for retaining the material in the desired configuration will be determined based on its intended use in the article of manufacture and the intended use of the article of manufacture itself (e.g., temporary vs relatively permanent use), and on the intended processes for the disposal of the material and the article of manufacture disposal at the end of its lifespan.

a. Simple NCE-Based Materials

Simple NCE-based materials can be used as plastic substrates for forming into articles having a variety of shapes, with the mechanical properties of such formed articles being due at least in part to structural framework provided by the matrix of dried, redispersible or redispersed NCEs that is integral to the simple NCE-based material. Simple NCE-based materials can thus be used to form articles that have advantageous mechanical properties such as strength and stability but that are also engineered to be dissolvable or degradable at an appropriate time for consumer use. Such articles are envisioned to be relatively temporary in duration, and can be disposed of by biodegrading or composting.

For example, this combination of mechanical properties and dissolvability/degradability allows containers to be constructed from such materials that have sufficient durability to retain their contents during consumer use, but that are furthermore susceptible to decomposition at the end of their intended lifespans. As used herein, the term “container” is to be construed broadly, referring to any receptacle, vessel, or partial or complete enclosure that can be employed in connection with an item or a product for holding, dispensing, delivering, segregating, suspending, structuring, packaging, storing, or portioning said item or product, or for providing similar functionalities derived from the partial or complete enclosure of said item or product therewithin. Exemplary containers include receptacles, vessels or enclosures of all shapes and geometries, whether rigid or flexible, and whether intended for temporary or durable use. Non-limiting examples include cylindrical vessels such as bottles, jars, cups, straws, barrels, cans, drums, tubs, and the like; rectilinear vessels such as boxes, crates, cartons, cases, and the like; flattened receptacles such as plates, trays, dishes, lids, holders, and the like; and delivery systems such as pill capsules or dissolvable foams that deliver a pharmaceutical, agricultural, or other active agent to an area targeted for application, protection, or treatment. Advantageously, containers can provide protection from shock, impact, and mechanical damage, and from elements of the external environment such as weather, pests and microbes; furthermore, containers can provide protection from oil, grease and water incursion and from leakage of fluids exuded by the contained product. For these reasons, containers are particularly useful for protecting food products.

This combination of mechanical properties and decomposability also allows containers to be constructed from simple NCE-based materials for deliberately ephemeral purposes, such as a container for a fertilizer or agricultural product that is intended to decompose over a very short period of time in order to release the product into the environment. This combination of properties also allows containers to be constructed for rapid or immediate dissolving upon encountering water, for example for delivering active agents for laundry or other home care purposes. Simple NCE-based materials, whose architecture is based on the three-dimensional arrangement of NCEs alone, are entirely bio-based, since they are formed from NC elements. Thus, they offer important alternatives to the petroleum-derived formulations that are used to produce conventional articles of manufacture used for similar purposes, and they provide a vehicle for engineering a combination of mechanical properties and dissolvability that are consistent with the particular purpose of the article.

A significant limitation to the use of simple NCE-based materials is their vulnerability to oil, grease and water: simple NCE-based materials are substantially made from NCEs in combination with other, often cheaper, filler materials such as pulp and pulp-derived substances which tend to offer little intrinsic resistance to the entry of water or oil/grease into the material and their passage therethrough. This vulnerability is exacerbated by the cost of NCEs themselves: NCEs can be admixed with cheaper bulking agents or fillers to reduce the overall cost of a NCE-based material. Pulp or pulp-based substances are frequently employed for this purpose. However, such a material, termed “pulp-dominant” is especially susceptible to the effects of water and grease. In a pulp-dominant material without any other treatment, exposure to water or oil/grease can lead to a loss of structural strength or an actual loss of integrity of a formed article made from such materials.

As used herein, the term “pulp-dominant” refers to a matrix or material in which pulp or a pulp-based material is present in sufficient quantities that it can have substantial effect for the mechanical properties of the material. A pulp-dominant matrix can require additional NCE or other reinforcement to make it as strong, stable, or durable as a non-pulp-dominant simple NCE-based material, depending on the ultimate use of the material; furthermore, such a material can be treated with barrier formulations to make them resistant to the effects of water, oil, and grease, depending on the ultimate use of the NCE-based material. As an example, a pulp-dominant simple NCE-based material can be used to form sheets for personal care items such as facial tissue or toilet paper without much if any additional reinforcement, while a similar material intended for use as a paper towel can require more reinforcement since its ultimate use requires more strength and resilience. A pulp-dominant material can also benefit from treatments to improve its oil and grease resistance and/or its water resistance, depending on the ultimate intended use for such a material.

Simple NCE-based matrices can therefore be treated with formulations that impart oil and grease resistance (oleophobicity) and/or water resistance (hydrophobicity) to the matrix itself or to those materials comprising such matrices. Water resistance in a material is often measured by the water vapor transmission rate, which measures a material's water vapor permeability in units of gm/m²/day, or in g/100 in²/day; the term “water resistance” (WR) thus includes resistance to liquid water and resistance to water vapor. Oil and grease resistance (OGR) and water resistance (WR, and collectively with OGR, “OGWR”) properties can thus be integrated into the materials themselves or into the articles formed therefrom. These OGWR properties can also be termed “barrier properties,” and a substances or formulation that produce barrier properties can be termed “barrier-producing formulation” or “barrier formulation.” A “barrier substance” refers to a substance that produces a barrier property. Both oil/grease resistance (or oleophobicity) and water resistance (or hydrophobicity) can be individually termed a barrier property.

Barrier properties can be tuned within a simple NCE-containing material to permit differential permeability of the material to various fluids (whether oil, grease, or water). As an example, in embodiments a barrier-producing formulation may impart both OGR and WVR properties to the article it treats, with the relative strength of each property being tunable by adjusting the ingredients selected for the formulation itself, and/or by adjusting the relative amounts of its ingredients, for example to emphasize hydrophobicity or oleophobicity.

In embodiments, NCEs alone, or NCEs modified with barrier-producing substances such as lignin, wax, fatty acids and the like, are able to impart a certain degree of oleophobicity or hydrophobicity to the simple NCE-based material, and their concentration can be adjusted to optimize this barrier property. Without being bound by theory, it is thought that the tight packing of NCEs can enhance the barrier properties that they provide. In addition, despite their intrinsic hydrophilicity, NCEs (either alone or modified with barrier-producing substances) can, under certain circumstances, be sufficiently tightly packed in simple NCE-based materials that they impart water resistant or vapor resistant barrier properties to those materials.

In embodiments, a wide range of additive ingredients can be combined to provide desired barrier properties. For example, a barrier-producing formulation that is suitable for use with simple NCE-based matrices can include a cellulose ether such as methylcellulose, and/or a resin acid. Alternative cellulosic ingredients for the barrier-producing formulation can include, without limitation, CMC (carboxymethyl cellulose), CMCNa (sodium carboxymethyl cellulose salt), CA (cellulose acetate), CDA (Cellulose diacetate), cellulose triacetate (CTA), CAB (cellulose acetate butyrate), CAPh (cellulose acetate phthalate), CAP (cellulose acetate propionate), EC (ethyl cellulose), HEC (hydroxyethyl cellulose), EHEC (ethyl hydroxyethyl cellulose), HPC (hydroxypropyl cellulose), HPMC (hydroxypropyl methylcellulose), HPMCP (hydroxypropyl methylcellulose phthalate), HPMCAS (hydroxypropyl methylcellulose acetate)). Methylcellulose is particularly advantageous in barrier-producing formulations for simple NCE-based matrices due to its oil and grease resistance, its high viscosity, and its unique lower critical solution temperature (LCST) that causes it to gel when heated. Resin acids and combinations thereof (such as rosin, gum rosin, pitch, and the like) can be used alone or in conjunction with methylcellulose to provide water resistance. Cellulose acetates are also particularly advantageous ingredients in barrier formulations, especially for food and beverage containers, given that they can produce both oleophobic and hydrophobic properties.

In more detail, resin acids are bio-derived gums that are tacky and water-insoluble in their native state, characterized as unsaturated diterpenecarboxylic acids with a phenanthrene ring structure, having the empirical formula C₁₉H₂₉COOH. Resin acids include abictic acid, palustric acid, levopimaric acid, neoabietic acid, dehydrogenated ibuptic acid, pimaric acid, isopimaric acid and sandaracopimaric acid. They can be separated into two categories according to their chemical structural formulas, abietic-type resin acids and pimaric type resin acids. The monomeric molecule of the abietic type resin acid has two conjugated double bonds and one isopropyl. Dehydrogenated abietic acid, abietic acid, palustric acid, and levopimaric acid are examples of abietic type resins. The monomeric molecule of pimaric-type resins has a methyl and vinyl at the C13 position and has two independent double bonds. This type of structure is predominantly found in pine-bearing resins and pine resin, such as pimaric acid, isopimaric acid, and sandaracopimaric acid, and pimaric resin acids.

Resin acids' carboxyl group(s) can react with a polyol (e.g. glycerol, erythritol, etc.) to form esters (thus binding three or four resin acid molecules together to create an “oligomer” of a basic resin acid building block such as abietic acid). Resin acids tend to be glassy and stiff at room temperature. Depending on plasticization, they can be softened by temperature increase, and amount of plasticizer used. Resin acids are compatible and miscible with a variety of oils/waxes to tune thermal or physical properties (such as but not limited to glass transition temperature, ductility, and hydrophobicity). For example, beeswax and carnauba wax are soluble in certain resin acids, thus affecting the melting and glass transition temperatures while also decreasing their solubility in solvents. Other examples of suitable oils and waxes to admix with resin acids include, without limitation:
Mineral oils and waxes (paraffins)
Beeswax
Carnauba wax
Flax seed wax
Candelilla
Lard
Coconut oil
Linseed oil
Eucalyptus essential oil
Cocoa butter
Sweet almond oil
Olive oil
Palm oil
Castor oil
Sunflower oil
Canola oil

The proportion of these ingredients in the barrier-producing formulation can be tuned to optimize its OGR properties and the WVR properties, and thus to engineer the desired amount of OGWR in the simple NCE-based material that are formed by adding the specific barrier-producing formulation to the simple NCE-containing matrix.

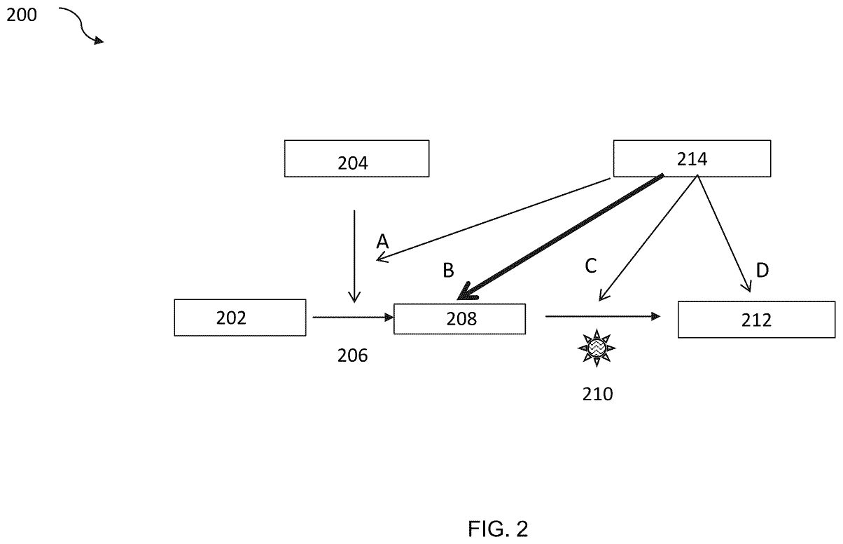

The block diagram of FIG. 2 illustrates schematically how the barrier-producing formulation can be added during the formation of the simple NCE-based matrix and its subsequent processing. The process 200 in FIG. 2 begins with providing a dried material 202 containing redispersible NCEs, where such dried material has been prepared substantially as described in connection with FIG. 1. The dried material 202 containing the redispersible NCEs is then ground/shredded and used as a dry ingredient, or suspended in a resuspending fluid 204 to resuspend the NCEs in the dried material 202 and to form a suspension 208 of the desired concentration of redispersed NCEs, substantially as described in connection with FIG. 1. The suspension 208 of redispersed NCEs is then subjected to drying 210 to produce the simple NCE-based matrix 212 that can then be used to form the simple NCE-based material, substantially as described in connection with FIG. 1. A barrier-producing formulation 214 can be added at points A, B, C, and/or D. In more detail, the barrier-producing formulation 214 can be added as part of the step 206 wherein the dried material 202 containing redispersible NCEs is treated with the resuspending fluid 204 to produce the suspension 208 of redispersed NCEs. For example, the barrier-producing formulation 214 can be added to the redispersing fluid 204, as indicated by its introduction at point A. The barrier-producing formulation 214 can also be added to the suspension 208 of redispersed NCEs, as indicated by its introduction at point B. The barrier-producing formulation 214 can also be added during the step of drying 210, in which the suspension 208 of redispersed NCEs is processed, ultimately to form the simple NCE-based material 212, as indicated by its introduction at point C. Finally, the barrier-producing formulation can be added to the simple NCE-based material 212, as indicated by its introduction point at point D. Although a single barrier-producing formulation 214 is depicted in this Figure, it is understood that a plurality of barrier-producing formulations or barrier-producing formulation ingredients can be added at the different introduction points. A first barrier-producing formulation can be added at one introduction point, and a second barrier-producing formulation can be added at a second introduction point. Combinations of barrier-producing formulations and their ingredients can be introduced at any point during the process, using methods familiar in the art, such as (without limitation) mixing in the formulations, spraying them onto or into the designated substrate, or painting them on its surface. Such barrier-producing formulations can include redispersed NCEs to enhance performance and act as pore closers in their interaction with the surface of the existing NCE-containing material onto which the coating is deposited. Barrier-producing formulations that do not contain redispersed NCEs can be applied to impart enhanced performance as well.

Examples of formulations for spraying onto or into substrates include the following:

An exemplary formulation to produce an oil, grease, and water-resistant barrier, to be used as a coating (by weight, based on a total formulation weight of 100 g) includes:
Cellulose acetate butyrate (CAB): 10 g
Rosin: 10 g
Acetone: 79 g
Plasticizer (for example, but not limited to, triacetin, triethyl citrate, acetyl triethyl citrate, tributyl citrate): 1 g

An exemplary formulation to produce an oil, grease, and water-resistant barrier to be used as a coating (by weight, based on a total formulation weight of 100 g) includes:
Methyl Cellulose (MC): 3 g
Redispersed NCEs (NFC or MFC or combinations thereof): 1 g
Water: 54 g
Rosin: 4 g
Ethanol or Acetone: 38 g
   Where the MC is solubilized in the water then combined with the redispersed NCEs. Simultaneously the rosin is solubilized in either ethanol or acetone. The two solutions can then be combined to produce an OGWR barrier.

An exemplary formulation for a hydrophobic coating includes the following ingredients combined to form a solution in acetone (by weight, based on a total formulation weight of 100 g):
Cellulose Acetate (CA): 3.5 g
Ethanol: 7 g
Acetone: 82.5 g
Gum Rosin (GR): 7 g

An exemplary formulation for an oleophobic coating includes the following ingredients combined to form an aqueous solution in water (by weight, based on a total formulation weight of 100 g):
Methyl Cellulose (Or any cellulose ether): 75 g.
Redispersed NCEs (NFC or MFC or combinations thereof: 25 g

In more detail, an exemplary simple NCE-based material having OGWR properties can be produced as follows, with the barrier-producing formulation being added to a suspension of redispersible or redispersed NCEs. A suspension of redispersible (in this case, redispersed) NCEs, prepared as discussed above, is provided, into which methylcellulose (MC) is added with or without a sugar alcohol plasticizer (glycerol, xylitol, maltitol, sorbitol, erythritol, mannitol, and the like). Adding these ingredients is intended to produce oleophobicity. The suspension of such redispersible or redispersed NCEs can contain NFCs, MFCs, or both. The suspension of such redispersible or redispersed NCEs can also include bulking agents such as pulp or pulp-based ingredients to provide more volume to the final simple NCE-based matrix and resulting materials. Separately, a solution of rosin is prepared by mixing rosin into an alcohol or ketone solvent (e.g., ethanol or acetone) to achieve a 10-100 wt % (wt rosin/wt solvent) solution of rosin in the solvent. After this solution has been prepared, with the rosin adequately dissolved, it can be emulsified in water using polyethylene glycol (PEG) at 1-25% relative to the weight of rosin, preferably using an in-line homogenizer, or it can be directly mixed into the MC-containing suspension of redispersible or redispersed NCEs. A small amount of the solvent used to prepare the mixture can be added to the suspension of NCEs, before the rosin mixture is added, to encourage homogenization. The mixing process can take place vigorously, for example pouring rosin-based formulation slowly into the NCE-containing resuspension at medium to high shear, or spraying as a fine mist into solution at relatively low shear, to nucleate a fine suspension of rosin in the liquid phase throughout the MC-NCE containing suspension. It is advantageous to add the rosin solution as a highly pressurized stream or to create a water-based emulsion, so that rosin particulate size is small. Following the combination of these ingredients the resulting mixture can be dried, producing the simple NCE-based matrix that can be processed to yield the simple NCE-based materials.

Rosin addition improves the hydrophobicity of the matrix. Rosin efficacy for hydrophobicizing can be increased by heat-treating the rosin before dissolving it in the solvent, for example by heating the rosin at about 200° C. for about 10-30 minutes to remove impurities such as turpentine. Heat treatment will also increase the softening point rosin from 45° C. to 59° C., making it more resilient when subjected to heat during later stages of processing. In an embodiment, rosin can be loaded at an amount of about 35 wt % relative to dry pulp weight, though amounts of rosin relative to dry pulp weight ranging from about 1 wt % to about 50 wt %, about 1 wt % to about 10 wt %, about 8 wt % to about 25 wt %, about 20 wt % to about 40 wt %, or about 35 wt % to about 55 wt % can be employed. In an embodiment the ratio of the redispersible or redispersed NCEs to MC is about 1:3. Other ratios of NCEs to MC ranging from 5:1 to 1:3 can be employed.

A simple NCE-based matrix having OGWR properties can be produced by combining the ingredients as described above. This matrix can then be formed into a simple NCE-based material that can be used to produce articles of manufacture. To improve the retention of other additives in the simple NCE-based material, retention aids can be added to the simple NCE-based matrix. Retention aids, typically cationic polymers or surfactants, are familiar in the papermaking industry; for example, substances such as chitosan or PDADMAC can be used as retention aids.

In exemplary embodiments, OGR and WVR materials as disclosed herein can be used as barrier-producing formulations with simple NCE-based materials, either as coatings to be applied to the surface of the material or as mix-in additives. In more detail, OGR and/or WVR formulations can be used as coatings, or can be mixed into the simple NCE-based material as described above, which then can be shaped (e.g., thermoformed) into a product.

As an example, containers or parts of containers formed from simple NCE-based materials can be prepared having OGR properties and/or WVR properties, enabling the containers to securely confine and deliver liquids, gels, or wetted solids to the consumer for other purposes. Such simple NCE-based materials can be pulp-dominant, with appropriate adjustments of amounts of NCEs and barrier-producing formulations, based on amount of pulp or pulp-based materials they contain. In embodiments, the barrier-producing formulation can also be applied to the surface of the simple NCE-based material prior to its forming or shaping into the formed article, or the barrier-producing formulation can be applied to the formed article after the forming or shaping has taken place. For example, the barrier-producing formulation can be applied superficially to a precursor material or article of manufacture, using conventional application procedures such as painting or blade painting, curtain coating, and the like, or spraying if the formulation is of a viscosity that is compatible with the selected spraying apparatus. In other embodiments, the barrier-producing formulation can be integrated into the simple NCE-based formulation (as described above) at any concentration; then, before molding/thermoforming takes place, the mixture can be heated to just above the lower critical solution temperature of the LCST polymer component of the barrier-producing formulation. This procedure allows the LCST polymer dispersed within the mixture to precipitate (or “crash out”) onto the fibers or the surface of the simple NCE-containing matrix structure.

In embodiments, a bulking agent such as pulp or a pulp-based material can be added to the simple NCE-based matrix to form a pulp-dominant simple NCE-based material, as mentioned above. In such a material, the NCEs can interact with the pulp or pulp-based bulking agent so that it coats them or fills in pores in between the fibers of the pulp or the fibers of the pulp-based material. In this capacity, the simple matrix or matrices formed within the simple NCE-based material can act as pore-closers to fill gaps in the pulp material. This pore-closing allows this sort of simple NCE-based material to be used with pulp or pulp-based substances to form high-value specialty paper products having properties that reflect the behavior of the NCE matrices. As an example, a paper product with NCE matrices embedded in its pores can offer or improve oil and grease resistance (especially in conjunction with other barrier materials), since the embedded NCE matrices close the pores within the paper substance that would otherwise allow the passage of grease through the product. As another example, a paper product with embedded NCEs in its pores can be engineered to form a releasable label backing or selective adhesive. In embodiments, barrier-producing formulations as described above can be added to the simple NCE-based material to enhance the effects of the NCE matrices as pore-closers, for example by imparting olcophobic or hydrophobic properties to the material which can then be carried over into pulp-dominant paper type products made therefrom.

In embodiments, filler particles can be added to simple NCE-based matrices and materials for bulking effect, and/or to act as pore closers. These filler particles can be used in addition to barrier-producing formulations, or instead of them; in either case, the filler particles can interact with the pulp fibers and the simple NCE matrices to impart barrier properties such as oleophobicity and/or hydrophobicity; as well, filler particles can affect mechanical properties such as strength, toughness, flexibility, and elasticity.

Such filler particles can include, without limitation, large or small particles of any shape, or mixtures of different sizes and shapes, made from natural or artificial materials, made with any method of processing (for example, without limitation, physical grinding, precipitation, emulsification), including organic or inorganic components; by way of illustration, particles useful for this purpose can comprise, without limitation, sand particulates, ceramic particulates, biomass materials or particulates, mineral particulates, resinous materials, glass materials, polymeric materials, rubber materials, composite particulate materials, chemically active materials such as fatty acids, surfactants, and sugar alcohols, organic materials such as wood or nutshells that have been chipped, ground, pulverized or crushed to a suitable size (e.g., walnut, pecan, coconut, almond, ivory nut, Brazil nut, and the like), seed shells or fruit pits that have been chipped, ground, pulverized or crushed to a suitable size (e.g., plum, olive, peach, cherry, apricot, etc.), coffee grounds, pinecone dust, sisal, rice hull ash, rice hull, coconut shell, cotton stalk and the like, chipped, ground, pulverized or crushed materials from other plants such as corn cobs, specific inorganic particles such as solid glass, glass microspheres, fly ash, silica, alumina, fumed carbon, carbon black, graphite, mica, boron, zirconia, talc, kaolin, titanium dioxide, calcium carbonate (e.g., precipitated calcium carbonate (PCC) or ground calcium carbonate (GCC)), wood flour, lignin, mica, dolomite, wollastonite, halloysite, calcium silicate, flame retardants (such as, but not limited to halogenated (chlorinated or brominated), phosphorous based, nitrogen based, inorganic/mineral based flame retardants, for example, hexabromocyclododecane (HBCD), triphenyl phosphate (TPP), tricresyl phosphate (TCP), phenol isopropylated, phosphate 3:1 (PIP 3:1) and the like, as well as combinations or composites of these or similar different materials. In embodiments, plant-derived organic materials such as (without limitation) wood or nutshells that have been chipped, ground, pulverized or crushed to a suitable size (e.g., walnut, pecan, coconut, almond, ivory nut, Brazil nut, and the like); seed shells or fruit pits that have been chipped, ground, pulverized or crushed to a suitable size (e.g., plum, olive, peach, cherry, apricot, etc.); coffee grounds, pinecone dust, sisal, rice hull ash, rice hull, coconut shell, cotton stalk, and the like; and chipped, ground, pulverized or crushed materials from other plants such as corn cobs, are especially advantageous for use as filler particles.

Advantageously, in certain embodiments filler particles can be selected that can be hydrophobic in nature, or that can be made hydrophobic (e.g., functionalized PCC), for example by linking or coating them with a hydrophobic material such as stearic or oleic acid. In embodiments, the filler particles can comprise waxes, either as the substance for the particle itself or as a coating for other particles, and these waxes can be in wax form or emulsion form (oil-in-water wax emulsion). For example, a waxy substance such as beeswax, soybean wax, carnauba wax, and the like, can be used, either as a base particle or as a coating for other filler particles. As used herein, the term “wax” refers to any hydrocarbon that is lipophilic and a malleable solid near ambient temperatures, typically having a melting point above about 40° C. As examples, waxes can include long-chain aliphatic hydrocarbons typically having 20-40 carbon atoms per molecule, or fatty acid/alcohol esters typically containing from 12-32 carbon atoms per molecule, such as myricyl cerotate, found in beeswax and carnauba wax. Filler particles can be mixed into the barrier-producing formulation to impart pore-clogging functionalities.

b. Composite NCE-Containing Materials

Composite NCE-containing materials, formed from composite matrices in which the redispersible or redispersed NCEs are integrated into existing matrices, can be used as plastic substrates for forming a multitude of products. After they are mixed into the existing matrix, the additive NCEs can be deployed as particles or as more elongated fibrous structures and can align with themselves in a straight or randomly oriented way, to form networks or other internal architecture in combination with the existing matrix that is embedded within the composite NCE-containing material. In embodiments, the three-dimensional matrix framework of the existing matrix substance is coated with and/or impregnated with additive NCEs to form the composite NCE-containing matrix, wherein the presence of the additive NCEs imparts a specialized property that exceeds those found in the existing matrix, or that is not found in the existing matrix. For example, the composite NCE-containing material can exhibit a specialized mechanical property such as strength, hardness, toughness, brittleness, stiffness, cohesion, durability, impact resistance, optical transparency, and the like, where the presence of the NCEs in the composite NCE-containing material produces or improves upon that specialized mechanical property.

As another example, the composite NCE-containing material can exhibit a specialized barrier property such as an OGWR property that can be present in the existing matrix but is improved in the composite NCE-containing material, or that is absent in the existing matrix but is provided in the composite NCE-containing material. In embodiments, NCEs alone, or NCEs modified with barrier-producing substances such as lignin, wax, fatty acids and the like, are able to impart a certain degree of oleophobicity or hydrophobicity to the composite NCE-containing material, and their concentration can be adjusted to optimize this barrier property. Without being bound by theory, it is thought that the tight packing of NCEs can enhance the barrier properties that they provide. In addition, despite their intrinsic hydrophilicity. NCEs (either alone or modified with barrier-producing substances) can, under certain circumstances, be sufficiently tightly packed in composite NCE-containing materials that they impart water resistant or vapor resistant barrier properties to those materials.

Combining redispersible or redispersed NCEs with an existing matrix can allow the presence of the NCEs to act as pore closers in their interaction with the existing matrix. Under these circumstances, the redispersible or redispersed NCEs can interact with the existing matrix so that it coats it, or fills in the pores or gaps within the network provided by the existing matrix. In embodiments, these pore-closing effects can be boosted when used in combination with other oil-and-grease-repellent additives. In this capacity, the NCEs and any matrices that they form can act as pore-closers to fill the gaps in the existing matrix, thereby acting as plugs to impair the passage of certain molecules, such as oil and grease, through the composite NCE-containing matrix. This mechanism is similar to the behavior or NCEs as pore-closers for simple NCE-based materials. Also, filler particles can be added to composite NCE-containing matrices, similarly to how filler particles can be added to simple NCE-based matrices. The role of filler particles has been described above in detail with reference to simple NCE-based materials; mutatis mutandis, that description can be applied to the use of filler particles for composite NCE-containing materials. Briefly, filler particles can be added to complex NCE-containing matrices for bulking effect, and/or to act as pore closers for simple pulp-based matrices, alone or in conjunction with other barrier materials. In various embodiments, filler particles can be used in addition to barrier-producing formulations, or instead of them; in either case, the filler particles can interact with the existing matrices and/or the composite NCE-containing matrices to impart barrier properties such as oleophobicity and/or hydrophobicity.

More generally, the process of formulating composite NCE-containing materials from composite NCE-containing matrices can be engineered in order to produce the desired material properties. The production of OGWR properties by the incorporation of barrier-producing formulations in such materials is one example of how composite NCE-containing matrices can be engineered to produce such material properties. Existing matrices can be formulated to make them especially suitable for combining with the redispersible or redispersed NCEs in order to form the composite NCE-containing matrices and to produce composite NCE-containing materials. For example, the degree of flexibility in a product formed from the composite NCE-containing materials can be fine-tuned by varying the composition of the existing matrix, the amount of additive NCEs used in the existing matrix to form the composite NCE-containing matrix, and/or the amount of various additives intended to optimize properties of the final composite NCE-containing material. By selection of appropriate additives and polymers for the existing matrix within which NCEs are integrated to form a composite material, such additives can produce properties such as structural strength, resilience, elasticity, water resistance, oil and grease resistance, and the like, for manufactured articles formed therefrom, in combination with biodegradability.

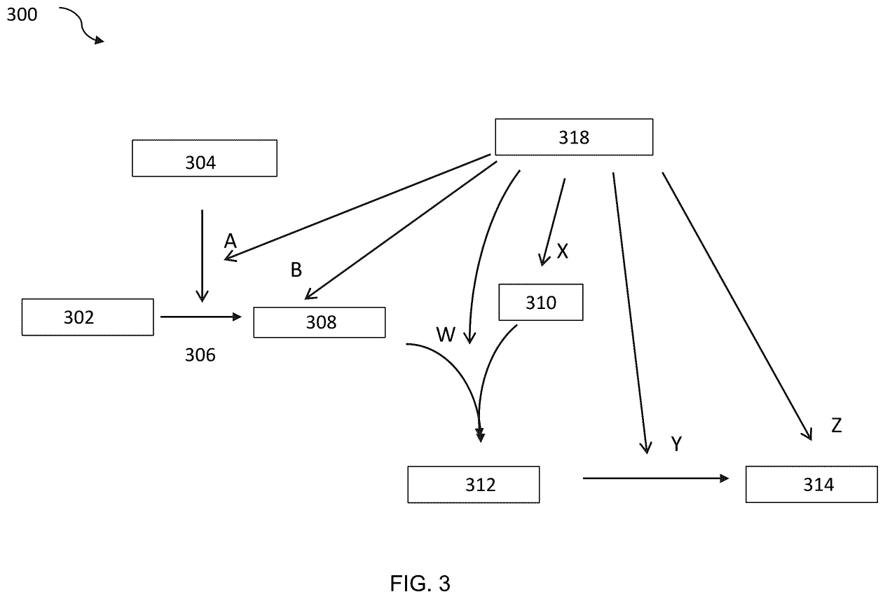

The block diagram of FIG. 3 illustrates schematically how the barrier-producing formulation can be added during the formation of the composite NCE-containing matrix and its subsequent processing. The process 300 in FIG. 3 begins with providing a dried material 302 containing redispersible NCEs, where such dried material 302 has been prepared substantially as described in connection with FIG. 1. The dried material 302 is then treated with a resuspending fluid 304 in a resuspending step 306 to form a suspension 308 of redispersed NCEs, substantially as described in connection with FIG. 1. The suspension 308 of redispersed NCEs is then combined with an existing matrix 310 to produce the composite NCE-containing matrix 312, substantially as shown in Step 5a in FIG. 1. The composite NCE-containing matrix 312 can be combined with additives and/or further processed to form a composite NCE-containing material 314. The barrier-producing formulation 318 can be added at points A and B substantially as described in connection with FIG. 1. Alternatively, or in addition, the barrier-producing formulation 318 can be added at one or more of points W, X, Y, and Z. In more detail; the barrier-producing formulation 318 can be added as the suspension 308 of redispersed NCEs 308 is mixed with the existing matrix 310, as indicated by point W; the barrier-producing formulation 318 can be added to the existing matrix 310 before it is mixed with the suspension 308 of redispersed NCEs, as indicated by point X; the barrier-producing formulation 310 can be added to the composite NCE-containing matrix 312 as it is processed to become the composite NCE-containing material 314, as indicated by point Y; and/or the barrier-producing formulation 310 can be added to the composite NCE-containing material 314, as indicated by point Z. For this last type of application, advantageously the barrier-producing formulation can be sprayable to permit easy application, whether to the surface of the composite NCE-containing material 314 or to the surface of formed articles manufactured therefrom (not shown). Although a single barrier-producing formulation 318 is depicted in this Figure, it is understood that a plurality of barrier-producing formulations or barrier-producing formulation ingredients can be added at the different introduction points W, X, Y, or Z. A first barrier-producing formulation can be added at one introduction point, and a second barrier-producing formulation can be added at a second introduction point. Combinations of formulations and/or barrier-producing formulations ingredients can be introduced at any point during the process.

In embodiments, barrier-producing formulations can be prepared that contain biopolymers as additives to impart OGWR properties or other useful properties to composite NCE-containing materials, similar to how such additives can be used with barrier-producing formulations that are combined with simple NCE-based materials. Such additives can be added to the barrier-producing formulation, which then can be combined with the composite NCE-containing matrix as described above. Biopolymers can include biopolyesters such as polyhydroxy-alkanoates and polylactic acid derivatives. Advantageously, certain exopolysaccharides such as pullulan, kefiran, cellulose, levan, gellan, and the like can be used to form films, which can be advantageous for those barrier-producing formulations that are used as coatings for composite NCE-containing materials and useful articles made therefrom. Such biopolymers can also include, without limitation, exopolysaccharides such as bacterial cellulose, kefiran, pullulan, levan, gellan, other naturally occurring polysaccharides such as alginate, lignin, carrageenan, gum Arabic, starch and plant glucomannans-like locust bean gum, mannan, guar gum, and the like, and cellulose derivatives. As used herein, those products created by the modification of the native cellulose polysaccharides are termed “cellulose derivatives,” “cellulosic polymers,” or “cellulosics.” Such modifications can include chemical modifications, such as cellulose degradation and derivatization of —OH groups. Acid/base, oxidative, biological, and mechanical processing are all examples of degradation reactions. Modifications that introduce new functional groups in the cellulose backbone include reactions such as carboxymethylation, oxidation, and addition reactions. Other reactions such as esterification, acylation, grafting, and etherification can also produce cellulose derivatives. Other examples of reactions producing cellulose derivatives are well-known in the field.

A variety of specialized properties of composite materials using NCEs have already been contemplated in industry, but their use has been hampered by the redispersion problems mentioned previously. The redispersion technologies disclosed herein facilitate the transportation of NCE compositions that can be concentrated or dried and then be resuspended to be combined with existing matrices, yielding composite NCE-containing materials. In embodiments, these redispersion technologies can produce a uniform mixture of high-aspect-ratio NCEs within the primary matrix-forming material, allowing enhancement of desirable specialized properties in the final composite, including mechanical properties such as are mentioned above. In other embodiments, NCE formulations produced using the redispersion technologies disclosed herein can be prepared so that they introduce or enhance specialized properties such as barrier properties that allow the composite NCE-containing material to have desirable degrees of oil and grease resistance and/or water vapor resistance.

Redispersible and redispersed NCEs produced as described herein can act as fillers in composite NCE-containing matrices. Fillers are understood to improve mechanical and barrier properties of organic and substances such as plastics, and/or to make them or products made from them more economical to produce or ship, for example by requiring less amounts of expensive ingredients, or by making them more lightweight. Redispersible and redispersed NCEs produced as described herein can also be combined with other bulking agents such as pulp or pulp-based substances to increase the final volume of the composite NCE-containing matrix while retaining strength through the presence of the additive NCEs. While NCEs have already been used as fillers in plastics, their use has been limited by their resistance to redispersibility.

The methods for NCE redispersion disclosed herein can permit the more widespread use of NCEs for purposes such as reinforcement of composite materials and plastic substrates, and can further permit a dramatic expansion of new uses. As used herein, the term “reinforcement” refers to an improvement of a mechanical characteristic that is found in the existing matrix pertaining to strength, hardness, toughness, brittleness, stiffness, cohesion, flexibility, durability, or impact resistance, or a provision of such a mechanical characteristic if it is not already present in the existing matrix. A composite NCE-containing matrix having improved mechanical properties as compared to the existing matrix can be termed “reinforced,” with the reinforcement of the composite NCE-containing matrix being attributable to the presence of the NCEs. NCEs can be used as fillers in a variety of environments, as the foregoing examples demonstrate.

In certain embodiments, the composite NCE-containing matrix is formed from a petroleum-derived existing matrix into which the redispersible or redispersed NCEs are incorporated. In other embodiments, the composite NCE-containing matrix is formed from a bio-based existing matrix into which the redispersible or redispersed NCEs are incorporated.

i. Petroleum-Derived Existing Matrices

In embodiments, petroleum-derived polymers are used to form the existing matrices that are combined with additive (redispersible or redispersed) NCEs to form composite NCE-containing matrices with advantageous properties. A variety of petroleum-derived polymers can be used as existing matrices to form composite matrices with NCEs, for example polyvinyl alcohol, high-density polyethylene, low-density polyethylene, polyvinyl chloride, acrylonitrile butadiene styrene, polypropylene, polylactic acid, polybutylene succinate, polyethylene succinate, polypropylene succinate, and the like. The addition of NCEs to these matrices can provide specialized properties such as a mechanical property, for example increased strength and/or flexibility, or a barrier property such as an oleophobic or a hydrophobic property or a water-vapor resistant property. Furthermore, redispersible or redispersed NCEs can be added to the matrices as ingredients in a formulation that also includes a bulking agent such as pulp or a pulp-based substance. Such formulations can provide added volume to the resultant composite NCE-containing matrix while the NCE component retains or improves its mechanical properties as compared to the existing matrix. The use of such formulations, comprising redispersible or redispersed NCEs and bulking agents, can reduce the need for other expensive ingredients and thus can lower the overall cost of the resultant composite NCE-containing matrix and materials produced therefrom.

However, the use of redispersible or redispersed NCEs as additive NCEs in combination with hydrophobic existing matrices presents challenges because the NCEs themselves are hydrophilic. While incorporation of additive NCEs into hydrophobic existing matrices can pose problems due to the weak interfacial strength between the hydrophobic polymer matrix and hydrophilic NC elements, the redispersible or redispersed NCEs can be further modified to become more hydrophobic so that a stronger interface is created. For use in a hydrophobic environment, the NCEs can be surface-modified to match the properties of the hydrophobic existing matrix in which they are to be incorporated, so that they are compatible with the existing matrix and can be regularly dispersed within it. In embodiments, surface modification of additive NCEs prepared in accordance with the methods disclosed herein can be performed, for example using a hydrophobic monolayer on the NCEs. Methods for this modification can include silane coupling, alkali treatment, acetylation, carbonylation, TEMPO oxidation, polymer grafting, bacterial modification, surfactant addition, and the like. In embodiments, NCEs that have been hydrophobized for use in hydrophobic matrices can be prepared so that they are not only redispersible upon drying but are also, by virtue of their hydrophobic coating, compatible with various hydrophobic polymeric existing matrices, such as thermoplastic and thermoset matrices (e.g., polypropylene, polyethylene, polystyrene, polyesters, poly(acrylates/methacrylates), rubbers, silicones, urethanes, epoxies, and the like, to yield strong and lightweight composite NCE-containing materials for further processing to provide articles of manufacture. Other modifications can include those that enhance the interfacial adhesion between the hydrophobic matrix and the hydrophilic NCEs such as incorporating another additive (e.g., a fatty acid or a surfactant) that has a polar head and a nonpolar tail; it would be understood that this additive could interact with both the hydrophobic matrix and the hydrophilic NCEs to improve their adhesion to each other.

As previously described, other additives to obtain desirable properties can be added to the composite NCE-containing matrices to produce composite NCE-containing materials useful as plastic substrates. Such additives can be added at any stage in the production of the composite NCE-containing material, for example, being added to the existing matrix, or to the composite NCE-containing matrix, or to the composite NCE-containing material. For example, plasticizers such as phthalate esters can be employed to make the material more pliable and versatile. Such a composite NCE-containing material containing a plasticizer can then be shaped by conventional techniques such as extrusion, calendaring, injection molding, thermoforming, blow molding, and the like, to produce formed articles. The redispersed NCEs embedded in the composite NCE-containing matrix act as reinforcers, such as fillers, particles, or fibers that improve the mechanical properties of the material that has been softened by the plasticizers.

In embodiments, redispersed NCEs can be added to improve the mechanical performance of recycled petroleum-derived plastics, i.e., plastic materials comprising petroleum-derived polymers, wherein petroleum-derived plastic is derived from a plastic material that has been recycled. Plastic waste can thus be repurposed to create a variety of formed articles, but significant deterioration in material properties can occur during the recycling process, largely attributed to high heat and mechanical stress. Additionally, contamination of the recycling stream commonly occurs due to lack of consumer awareness with proper recycling habits and sorting errors in the recycling facility. Deterioration (molecular weight reduction, chain scissions, defects, etc.) and the presence of impurities both contribute to reduced strength of the recycled plastic compared to its virgin counterpart. Incorporating redispersed NCEs into recycled plastic feedstock is able to boost the weakened matrix. NCEs can be combined with powder, flakes, or other forms of recycled plastic. The recycled plastic feedstock can be a specific polymer or copolymer blend, it can also be a mixture of various recycled plastics. Redispersed NCEs may be combined with the recycled feedstock prior to thermal processing, or during thermal processing. For example, redispersed NCEs can feed into an extruder for mixing and dispersing with recycled molten polymer feedstock being processed through the screws. Produced articles may be suitable for single use applications such as food utensils, (such as food cutlery, plates, and straws), or consumer good packaging, or for long term applications such as furniture including tables, chairs, cabinets, and the like.

ii. Bio-Based Existing Matrices

In embodiments, bio-based polymers are used to form the existing matrices that are combined with additive NCEs to form composite NCE-containing matrices with advantageous properties. Under these circumstances, all the structural components of the composite NCE-containing matrix are bio-based, as is the composite NCE-containing material formed from the composite NCE-containing matrix. This composite NCE-containing material can be used as a plastic substrate to be formed into articles of manufacture. Producing this plastic substrate from bio-based components (i.e., redispersible or redispersed (additive) NCEs and a bio-based existing matrix) offers sustainability benefits, both in eliminating reliance on petrochemical raw materials and in facilitating the degradation and disposal of products formed from such plastic materials.

In those embodiments that use bio-based polymers to form the existing matrix, the constitutive bio-based polymer forming the existing matrix can be a homopolymer, copolymer, polymer blend, or any combination of the foregoing. Additive ingredients can be combined with the constitutive bio-based polymer to optimize properties of the existing matrix. For example, cellulose acetate (CA) and cellulose butyrate (CAB) can be blended together in an acetone solution or mixed together in a molten state under high shear such as extrusion, to form an existing matrix; alternatively, one of the two cellulosic polymers could be used independently. Additional or alternative cellulosic polymers that can be used for the existing matrix include cellulose acetate propionate, methyl cellulose, hydroxypropyl methyl cellulose, hydroxypropyl cellulose, sodium carboxymethyl cellulose, carboxy methyl cellulose, cellulose acetate phthalate, hydroxyethyl cellulose, chitosan, and the like. Polyhydroxyalkanoates (PHAs), including poly-3-hydroxybutyrate (PHB), polyhydroxyvalerate (PHV), polygydroxyhexanoate (PHH) and the like can also be used to form a matrix. Polybutylene succinate (PBS), polybutylene succinate-co-adipate (PBSA), and the like produced from biomass can also be used to form a matrix. In embodiments, one or more plasticizers can be added to the existing matrix to soften and increase its flexibility. Bio-based plasticizers can be added into the existing matrix can include fatty acids, polyols, epoxidized triglyceride vegetable oils, alkyl esters of adipic and citric acids, and the like; examples of such plasticizers include, without limitation, triglycerin, tributyl citrate, triethyl citrate, acetyl triethyl citrate, polyethylene glycol, epoxidized soybean oil, oleic acid, and the like. Bio-based resinous materials, such as gum rosin, can be added to hydrophobize, stiffen, and/or bind the existing matrix and limit the degree of flexibility; such materials have other advantages, for example acting as a glue-like substance to affix matrix pieces to each other or to form bridges between them. Such materials can have the additional advantage of aiding in hydrophobization of the matrix and any subsequent materials derived therefrom if water resistance is desired for end use. Further additives can be included to optimize material properties for end use applications. For example, fillers and bulking agents can be added: pulp can be included as a filler or bulking agent in the existing matrix to reduce cost and improve texture; wood flour, saw dust, ash, mineral powders, lignin, and other low cost filler particulates can be used to reduce cost and/or close pores within a matrix; precipitated calcium carbonate and stearic acid can be added in the existing matrix to improve hardness and hydrophobicity, and precipitated calcium carbonate alone can be added to act as a nucleation agent or to provide brightness. Alternatively, or in combination with other additives, an oil-grease resistant and/or water-resistant (OGWR) formulation can be incorporated into the existing matrix to obtain hydrophobicity and oleophobicity as desired. Biodegradability-boosting additives can be used to aid in quick decomposition of the matrices after disposal; for example, silica particles can be integrated into a CAB-plasticized matrix.

As examples, photocatalysts, pro-oxidants, and enzymes may be used to accelerate the degradation of NCE-containing materials such as plastics once they enter the landfill. Using the example of enzymes, and without being bound by theories, it is understood that the following mechanisms explain the activities of certain of these biodegradability-boosting additives. To degrade the different cellulose derivatives first the functional groups need to be broken off and then the β-1,4-linkages in the cellulose backbone are able to further break apart. Unmodified cellulose can be degraded by cellulase and β-glucosidase enzymes. Lipase or acetylesterase are examples of enzymes that can be used to hydrolyze the acetyl group in cellulose acetate. By incorporating enzymes into the plastic matrix, their activity can speed up its degradation, for example while it resides in a waste facility or landfill. Methods for incorporating enzymes into the matrix can include physical adsorption, covalent binding, crosslinking, and encapsulation. Additionally, enzymes can be immobilized onto particles and then incorporated into the existing matrix for better retention and distribution. Moreover, enzyme loading and enzyme selection can be adjusted to speed up or slow down the rate of degradation under different circumstances. For example, enzymes that are active in specific temperature ranges and pH environments can be selected to initiate degradation when the NCE-containing plastic material ends up in home compost or soil, or instead when the plastic material is intended for a more delayed degradation process when it is consigned to a landfill.

Ultraviolet (UV) resistance can also be imparted to the existing matrix or the composite NCE-containing matrix with additives that absorb or stabilize UV radiation. For example, carbon black or other dyes that absorb UV light can be added as pigments. In embodiments, lignin, a bio-based material that contains different UV functional groups including phenolic units, ketones, chromophores, and conjugated double bonds that can impart UV resistance, can be incorporated as a UV absorbing additive into the polymer matrix to enhance long term stability. In embodiments, lignin can be combined with the NCE-containing matrix for in articles of manufacture (e.g., sunglass frames) that are commonly exposed to UV rays.

In embodiments, the existing matrix or the composite NCE-containing matrix can be magnetized with additives such as gamma ferric oxide. While the additives are described above as being added to the existing matrix, it is understood that they can be introduced directly into the composite matrix formulation (i.e., after the additive NCEs are combined with the existing matrix) in addition to or instead of introducing them into the existing matrix.

In an embodiment, a composite NCE-containing matrix for use in a composite NCE-containing material can be prepared as follows. In this embodiment, the bio-based existing matrix is prepared to include performance-enhancing additives, and this existing matrix is then combined with the redispersible or redispersed (additive) NCEs. In an embodiment, to prepare the bio-based existing matrix, the matrix-forming ingredients are dissolved in a solution of acetone or water dependent on the matrix's solubility parameters to form a solution containing about 2 wt % to about 25 wt %, about 5 wt % to about 15 wt %, about 5 wt % to about 50 wt %, or about 20 wt % to about 75 wt % of those ingredients, for example, a 12 wt % solution of those ingredients; in other embodiments, the solvent may not be needed. Thermal processing and high shear mixing can be used to create a hot melt of the matrix material. Powder, pellet or other forms of the matrix can be fed into a twin screw extruder and heated into a softened state that can be combined with redispersible NCEs and other additives. Matrix-forming ingredients can include constitutive polymer ingredients (e.g., cellulose acetate (CA), cellulose acetate butyrate (CAB), or the like, and other cellulose ethers such as methyl cellulose, carboxymethyl cellulose, hydroxypropyl cellulose, carboxymethyl cellulose, sodium carboxymethyl cellulose, hydroxymethyl cellulose, and the like, polydroxyalkanoates (PHAs) such as poly-3-hydroxybutyrate (PHB), polyhydroxyvalerate (PHV), polygydroxyhexanoate (PHH), polybutylene succinate (PBS), and the like, or combinations of such polymer ingredients) can be combined with plasticizers (e.g., triacetin, triethyl citrate, acetyl triethyl citrate, glycerol, xylitol, trehalose, sorbitol, mannitol, polyethylene glycol, polypropylene glycol, epoxidized soybean oil, castor oil, palm oil, and the like), along with rosin or derivatives thereof, fillers such as calcium carbonate or silica, bulking agents such as pulp or pulp-based materials, and/or fatty acids (preferably saturated) such stearic acid, lauric acid, palmitic acid, oleic acid, and the like. As an example, the CAB or other biopolymer can be added in a range from about 55% to about 95%; the plasticizer can be added in a range from about 0.1% to about 209%; the gum rosin can be added in a range from about 109% to about 409%. As another example, the CAB or other biopolymer can be added in a range from about 60% to about 90%; the plasticizer can be added in a range from about 0.1% to about 20%; stearic acid can be added in a range from about 5% to about 259%, and calcium carbonate can be added in a range from about 3% to about 17%, with the ratio of stearic acid to calcium carbonate at about 3:2. In another example, HPC or other biopolymer can be added in a range from about 55% to about 95%; the plasticizer can be added in a range from about 5% to about 40%, the gum rosin can be added in a range from about 10% to about 40%. As yet another example, HPC or other biopolymer can be added in a range from about 5 to about 50%; the plasticizer can be added in a range from about 0.5% to about 30%.

For example, ingredients including rosin, a plasticizer, and cellulose acetate butyrate (or any other biopolymer or combination of biopolymers) are combined along with other additives; under certain circumstances the order of combination can matter. In embodiments, the least viscous ingredients are combined first (rosin, PCC, stearic acid), with subsequent addition of the CAB, followed by addition of the plasticizer. The solution is stirred until the mixture is homogeneous and no clumps remain. This solution thickens to provide the existing matrix into which the additive NCEs are to be incorporated.

In parallel, the additive NCEs are prepared. In an embodiment, a selected amount of dried, redispersible NC-containing material prepared as described above is resuspended in a resuspending fluid such as water, mixing thoroughly with an overhead mixer.

In this way a formulation of redispersed additive NCEs is produced. In an embodiment, a formulation of redispersed NCEs can contain an amount of redispersed NCEs suitable to achieve the desired properties in the composite NCE-containing material. An amount of redispersed NCEs ranging from about 1% to about 50% (wt %) of the entire composite NCE-containing matrix can be used, with a range from about 5% to about 40% being advantageous. Using less water for this formulation will facilitate the drying of the material into which the additive NCEs are to be incorporated, assisting with its moldability. This formulation of additive NCEs is then combined with the existing matrix to produce the composite NCE-containing matrix. In this embodiment, no further ingredients are added to the composite NCE-containing matrix, since the appropriate ingredients have been added to the existing matrix already. A surfactant such as capryl glycoside can be added; without being bound by theory, it is understood that such an additive can bridge polar and non-polar components during mixing and processing. The composite NCE-containing matrix and any other desired ingredients can then be mixed under high shear by an overhead stirrer, a high shear mixer, a twin-screw extruder, and the like, to yield the composite NCE-containing material. This initial forming process can be adjusted based on the viscosity requirements for the manufacturing process being used to produce the formed article from the composite NCE-containing material.

4. Articles of Manufacture with OGWR Properties
a. OGWR Properties in General

In embodiments, barrier-producing formulations can be prepared to emphasize OGR properties or WVR properties or both; in embodiments, barrier-producing formulations can include both types of properties, and the formulation components can be tuned to accentuate either the OGR or the WVR properties or to balance them. For example, a range of cellulosic polymers exists, with the various polymers having different degrees of hydrophobicity or oleophobicity, so that a cellulose polymer can be selected to produce the desired degree of OGR and/or WVR. Barrier-producing formulations to produce water resistance may include a variety of cellulose-based polymers, and specifically ones that are more hydrophobic. Overall, cellulose-based polymers tend to be oleophobic (hydrophilic), so it can be beneficial to include other materials in a barrier-producing formulations if more water resistance is desired. For example, methyl cellulose provides good oil/grease resistance, but not as much water-resistance. A mixture of methyl cellulose (MC) and cellulose acetate (CA) can be provided to tune for both OGR and WVR properties. LCST polymers discussed work well for oil resistance, but the films/coatings created with them are soluble at room temperature, causing their water resistance properties to be less efficient. Cellulose acetate and lipids are some examples of additives that can be used to tune barrier-producing formulations to be more hydrophobic, and the combination of this component with a more oleophobic material can provide both oil and water resistance. Cellulose acetate, notably, can provide both hydrophobic and oleophobic properties. Cellulose acetate and other cellulose acetate derivatives (for example, without limitation cellulose acetate butyrate), are unique in that they also have a degree of oleophobicity, in addition to their strong hydrophobicity. Similarly, certain fillers have more hydrophobic or oleophobic properties: for example, a filler such as wax can be selected to increase hydrophobicity, or, for example, a large surplus of NCEs can be added as pore-blockers to increase oleophobicity. Fatty acids, on their own or paired with charged binder agents such as a mineral (e.g., calcium carbonate paired with stearic acid) may also be used to increase hydrophobicity.

In embodiments, substances such as NCEs, MC. HPMC, CMC, NaCMC, CA, CAB, chitosan, rosin, lignin, vegetable proteins (such as pea protein, zein, and the like), and/or any combination thereof can be employed as oleophobic substances to provide oil resistance; in embodiments, substances such as NCEs, MC, CA, CAB, chitosan, rosin, hydrophobized starch, lignin, pea protein, zein, and/or any combination thereof can be employed as hydrophobic substances to provide water and/or water vapor resistance.

In more detail, depending on the balance and amounts of ingredients, barrier-producing formulations can be classified in three general categories: 1) those providing balanced OGR and WVR properties; 2) those providing some or no hydrophobicity but substantial olcophobicity; and 3) those providing some or no oleophobicity but substantial hydrophobicity. Articles incorporating Category 1 barrier-producing formulations can be used for applications such as food packaging in which both oil repellency and water repellency are advantageous. Articles incorporating Category 2 barrier-producing formulations can be used for those applications in which oil resistance is the more important attribute, for example in containers for oils or greasy materials, and for packaging for premeasured amounts of oil-based products such as salad dressings or cosmetic lotions, or for use as more durable vessels that can contain motor oil and similar fluids, instead of the metal containers in use for this purpose. Articles incorporating Category 3 barrier-producing formulations can be used for those applications in which water repellency (even waterproofing) is the more important attribute, for example in coffee cups and six-pack holders for beverage cans, or in grocery bags and other containers (such as cardboard boxes) or wrappers intended to be substantially water-resistant or leak-proof.

b. Exemplary Oleophobic and Hydrophobic Articles of Manufacture

The omnipresence of plastic products provides a wide range of other opportunities for substituting NCE-containing materials as described herein for the conventional petroleum-derived plastics that are currently employed. In view of the environmental challenges that accompany the production of conventional petroleum-derived plastics and the disposal thereof, the composite NCE-containing materials as disclosed herein offer welcome alternatives. Illustrative examples include, without limitation, transaction cards, plastic bottles, packaging and wrappers, space fillers (shock, sound thermal insulation), films and sheets, drinking straws and food utensils such as cutlery, enhanced OGWR and strength of paper-based products (such as, without limitation, cardboard, paperboard and any fiber-based goods), structural plastics, nail polish and foams, and the like. Bio-based NCE-containing materials for producing useful articles of manufacture can be customized and engineered to produce desired performance properties and degradability.

i. Transaction Cards

Transaction cards, familiar in routine commercial applications, are small, lightweight, easily portable devices used for accomplishing administrative transactions such as transferring payments, opening entryways, providing identification, and the like. Such transaction cards are ubiquitous in modern commerce. Examples include credit cards, debit cards, prepaid gift cards, (collectively “payment cards”) transportation passes, identification cards, insurance cards, hotel keys, and the like. These are typically formed from petroleum-derived substances that provide a lightweight and durable substrate for shaping, printing, and embedding specialized components such as iron oxide for magnetic stripes, inks, dyes, and chips. They are typically made as laminates of PVC, a petroleum-derived plastic that takes hundreds of years to degrade. As of 2020, it was estimated that six billion payment cards alone were in circulation; each year 30 million kg of PVC is used for the issuance of such cards.

While it is recognized that these transaction cards can include other materials besides petroleum-derived plastics, such as metals, glass, silicon, and resins, converting from the petroleum-derived plastic sources to bio-based ones can have distinct advantages for disposal of these cards. For example, in cases where the cards or fragmented residua thereof are incinerated in a recycling facility, a bio-based material would generate less toxic gas than petroleum-derived alternatives. Also, bio-based materials that can biodegrade can undergo programmed decomposition in waste management facilities, so that their incineration can be avoided.

Using the methods described above, more environmentally friendly alternative substrates for transaction cards can be produced by combining an existing bio-based matrix with redispersed (additive) NCEs to produce a composite NCE-containing matrix. As previously discussed, the composite NCE-containing matrix in combination with any desirable additives constitutes the composite NCE-containing material that can be used as the plastic substrate for forming the transaction cards. For such products, it is advantageous to include water-resisting additives so that the card retains its integrity throughout its lifetime.

A basic formulation for the composite NCE-containing material useful in forming transaction cards can include the following ingredients combined to form a 5 wt % to 50 wt %, for example a 12 wt % solution in acetone, or as solids in a high shear heat mixer such as a hot melt extruder (by weight, based on a total formulation weight of 100 g):
Cellulose Acetate Butyrate (CAB): 36 g
Redispersed NCEs (NFC or MFC or combinations thereof): 36 g
Gum Rosin (GR): 26 g
Plasticizer (triacetin, triethyl citrate, or acetyl triethyl citrate): 2 g

While specific amounts for these ingredients are provided for the exemplary formulation above, it is understood that ranges of these ingredients can be added to create other formulations having advantageous properties. As examples, the nanocellulose component can added in a range from about 5% to about 50%; the CAB can be added in a range from about 30% to about 70%; the plasticizer can be added in a range from about 0.1% to about 15%; the gum rosin can be added in a range from about 5% to about 45%. In this formulation, the CAB in combination with the gum rosin and plasticizer can produce an existing matrix to be combined with the additive NCEs to yield the composite NCE-containing material. In those composite NCE-containing materials having a relatively larger amount of CAB, the CAB will have more influence on the properties of the overall composite NCE-containing material, as compared to the influence of the NCEs; conversely, in those composite NCE-containing materials having a relatively larger amount of redispersed NCEs, the NCEs will have more influence on the properties of the overall composite NCE-containing material, as compared to the influence of the CAB. In embodiments, the redispersed NCEs can be combined with a bulking agent such as pulp or a pulp-based material, to be added to the CAB-based existing matrix.

A basic formulation for the composite NCE-containing material useful in forming transaction cards can include the following ingredients combined to form a 5 wt % to 50 wt %, for example a 12 wt % solution in acetone or as solids in a high shear heat mixer such as a hot melt extruder (by weight, based on a total formulation weight of 100 g):
A cellulose derivative such as Cellulose Acetate Butyrate (CAB): 41 g.
Redispersed NCEs (NFC or MFR or combinations thereof): 28 g
Pulp: 9 g
Capryl Glucoside: 2 g
Plasticizer (triacetin, triethyl citrate, or acetyl triethyl citrate): 4 g
Gum Rosin: 16 g

This basic formulation can be modified in order to produce a composite NCE-containing material that yields a flexible card with enhanced hardness. Such a formulation can include the following ingredients combined to form a 5 wt % to 50 wt %, for example a 12 wt % solution in acetone or as solids in in a high shear heat mixer such as a hot melt extruder (by weight, based on a total formulation weight of 100 g):
A cellulose derivative such as Cellulose Acetate Butyrate (CAB): 36 g
Redispersed NCEs (NFC or MFC or combinations thereof): 36 g
Plasticizer (triacetin, triethyl citrate, or acetyltriethyl citrate): 2 g
Stearic Acid: 16 g
Precipitated Calcium Carbonate (PCC): 10 g

While specific amounts for these ingredients are provided for the exemplary formulation above, it is understood that ranges of these ingredients can be added to create other formulations having advantageous properties. As examples, the nanocellulose component can added in a range from about 5% to about 50%; the CAB can be added in a range from about 30% to about 70%; the plasticizer can be added in a range from about 0.1% to about 15%; the stearic acid can be added in a range of about 1% to about 12%; calcium carbonate (PCC) can be added in an amount of about 0.6% to about 8%, with a desirable stearic acid: PCC ratio of about 3:2. In those composite NCE-containing materials having a relatively larger amount of CAB, the CAB will have more influence on the properties of the overall composite NCE-containing material, as compared to the influence of the NCEs; conversely, in those composite NCE-containing materials having a relatively larger amount of redispersed NCEs, the NCEs will have more influence on the properties of the overall composite NCE-containing material, as compared to the influence of the CAB. In embodiments, the redispersed NCEs can be combined with a bulking agent such as pulp or a pulp-based material, to be added to the CAB-based existing matrix. In this formulation, the CAB in combination with the gum rosin and plasticizer can produce an existing matrix to be combined with the additive NCEs to yield the composite NCE-containing material. Not to be bound by theory, it is understood that the addition of a fatty acid (e.g., stearic acid) is amphiphilic, thus providing hydrophobic properties to the matrix and facilitating the incorporation of the hydrophilic PCC particles into the matrix; the PCC particles can act as a hardening reinforcement agent in the CAB matrix.

Barrier-producing formulations can be integrated into the composite NCE-containing materials that are used to form transaction cards to produce OGWR properties. In embodiments, hydrophobic properties are imparted to the composite NCE-containing material by including a hydrophobizing agent in the existing matrix or composite NCE-containing so that the final transaction card product is water-resistant and more durable. In other embodiments, a bio-based hydrophobic and/or oleophobic coating can be painted on the surface of the formed transaction card product or on the surface of one or more layers of composite NCE-containing materials that are laminated together to form the transaction card. Suitable hydrophobizing agents include, without limitation, those organic compounds having a highly polar region and a non-polar region, allowing the compound to bond or complex with the hydrophilic NCEs and to provide a non-polar outward-facing surface. As examples, hydrophobic agents can be fatty acids such as stearic acid, lauric acid, palmitic acid, oleic acid and the like; surfactants such as fatty amines or fatty alcohols; rosin components such as abietic acid, neoabietic acid, palustric acid, pimaric acid, isopimaric acid, and dehydroabienic acid; and natural waxes such as lanolin, beeswax and carnauba, and the like. Hydrophobizing agents can include silanes, siloxanes, or silica micro/nanoparticles, but these are less advantageous for the materials disclosed herein due to their impact on the environment.

Formulations for hydrophobizing, including formulations that can be added into the composite NCE-containing matrix and formulations that can be coated on the surface of one or more layers of composite NCE-containing materials can include ingredients such as cellulose acetate (CA) in a range from about 25% to about 70%; gum rosin (GR) in a range from about 25% to about 70%; and a plasticizer such as triacetin, triethyl citrate, or acetyl triethyl citrate in a range from about 1% to about 20%. To produce a formulation for hydrophobizing, the foregoing ingredients can be dissolved in an ethanol/alcohol solvent mixture, at a ratio of about 0.1% to about 20% hydrophobizing ingredients (wt %) to about 10% to about 50% ethanol (wt %) to about 50% to about 70% acetone (wt %).

An exemplary formulation for such a hydrophobic and oleophobic coating can include the following ingredients combined to form a solution in acetone (by weight, based on a total formulation weight of 100 g):
Cellulose Acetate (CA): 7 g
Ethanol: 14 g
Acetone: 71 g
Gum Rosin (GR): 7 g
Plasticizer (triacetin, triethyl citrate, or acetyl triethyl citrate): 1 g

An exemplary formulation to produce an oil, grease, and water-resistant barrier to be used as a coating (by weight, based on a total formulation weight of 100 g) includes:
Methyl Cellulose (MC): 3 g
Redispersed NCEs (NFC or MFC or combinations thereof): 1 g
Water: 54 g
Rosin: 4 g
Ethanol or Acetone: 38 g

An exemplary formulation for an oleophobic coating includes the following ingredients combined to form an aqueous solution in water (by weight, based on a total formulation weight of 100 g):
Methyl Cellulose (Or any cellulose ether): 75 g
Redispersed NCEs (NFC or MFC or combinations thereof: 25 g
   ii. Plastic Bottles

Plastic bottles are conventionally formed from multiple types of petroleum-derived polymers, including, without limitation, polyethylene terephthalate, polyethylene, polypropylene, polycarbonate, and the like. Such articles of manufacture are in widespread use commercially, serving as containers for a virtually limitless array of liquid and solid substances, such as foodstuffs (e.g., condiments, cooking oils, salad dressings, and the like), soaps, shampoos, household products, industrial products, personal care items, cosmetics, and pharmaceuticals. A significant environmental challenge is posed by their durability after the end of their useful life: the materials of which these items are formed can take hundreds or thousands of years to decompose. Plastic bottles used as containers for drinking water exemplify the burden that these items impose on the environment. Over 80% of the plastic water bottles that are produced end up in landfills; it is estimated that over 2 million tons of discarded water bottles currently reside in landfills, where they can remain reasonably intact for centuries.

Using the methods disclosed herein, a biobased flexible plastic substrate can be produced for manufacture of plastic bottles, by combining an existing matrix formed from bio-derived polymers with a population of redispersed NCEs produced as described above. The redispersed NCEs combined with the existing matrix can therefore form a biobased composite NCE-containing matrix that can be used to replace the non-degradable plastics currently being formed into plastic bottles and similar formed containers. The use of the redispersed NCEs in the composite matrix has the additional advantage of creating a physical barrier to prevent oxygen molecules from penetrating through a material. Such a plastic substrate can be engineered to retain its integrity during a predetermined lifespan, while being adapted for decomposition (e.g., through biodegrading or composting) at the end of its designated useful life.

An exemplary formulation to produce a plastic bottle can include the following ingredients combined in a solution of acetone or as solids in a high shear heat mixer such as a hot melt extruder (by weight, based on a total formulation weight of 100 g):
Cellulose Acetate Butyrate (CAB): 60 g
Redispersed NFC: 10 g
Gum Rosin (GR): 25 g
Plasticizer (triacetin, triethyl citrate, or acetyl triethyl citrate): 5 g

An exemplary formulation to produce a plastic bottle can include the following ingredients combined in a solution of acetone or as solids in a high shear heat mixer such as a hot melt extruder (by weight, based on a total formulation weight of 100 g):
Cellulose Acetate Butyrate (CAB): 52 g
Redispersed NFC: 17 g
Pulp Fiber: 6 g
Gum Rosin (GR): 20 g
Plasticizer (triacetin, triethyl citrate, or acetyl triethyl citrate): 5 g

While specific amounts for these ingredients are provided for the exemplary formulation above, it is understood that ranges of these ingredients can be added to create other formulations having advantageous properties. As examples, the nanocellulose component can added in a range from about 1% to about 30%; the CAB can be added in a range from about 30% to about 90%; the plasticizer can be added in a range from about 1% to about 35%, preferably in a range from about 15% to about 25%; rosin can be added in a range of about 5% to about 25%. In those composite NCE-containing materials having a relatively larger amount of CAB, the CAB will have more influence on the properties of the overall composite NCE-containing material, as compared to the influence of the NCEs; conversely, in those composite NCE-containing materials having a relatively larger amount of redispersed NCEs, the NCEs will have more influence on the properties of the overall composite NCE-containing material, as compared to the influence of the CAB.

In producing an appropriate composite NCE-containing matrix, the ingredients listed above can be added within ranges intended to optimize certain desirable properties. For example, a lower concentration of nanocellulose (e.g., between about 1% and about 15%, with less nanocellulose resulting in better optical clarity) can be employed to achieve a desired degree of mechanical strength and optical clarity. A higher concentration of plasticizer as compared to the transaction card formulation, for example an amount of plasticizer above 5 wt % of the total recipe, will aid in achieving desirable external characteristics such as glossiness or smoothness, along with introducing more flexibility into the formed object. For products that need more durable structure (e.g., shampoo bottles or pill containers) a formulation with less plasticizer can be used, and the walls of the container can be made thicker. To manufacture the plastic bottle from the composite NCE-containing material, it can be heated and shaped using conventional techniques such blow molding.

When used to contain aqueous fluids, a plastic bottle made from the composite NCE-containing material requires hydrophobic properties in order to prevent leakage. When used to contain oil-based liquids such as cooking oils, oleophobic properties are required in order to prevent leakage. Barrier-producing formulations can be integrated into the composite NCE-containing materials that are used to form plastic bottles to produce the required OGWR properties. In embodiments, hydrophobic properties are imparted to the composite NCE-containing material by including a hydrophobizing agent in the existing matrix or composite NCE-containing so that the product is water-resistant and more durable. In other embodiments, a bio-based hydrophobic coating can be painted on the surface of the formed transaction card product or on the surface of one or more layers of composite NCE-containing materials that are laminated together to form the transaction card.

iii. Packaging for Consumer Goods

While similarities exist between the requirements for fabricating plastic bottles and the requirements for fabricating other sorts of packaging for consumer goods, the properties of these different product categories will differ because they are used for different purposes. For example, plastic bottles can have a fairly prolonged lifespan compared to other types of containers, and they must remain water and/or oil impermeable during their entire lifespan, while packaging for other products can be designed for shorter lifespans or less demanding performance requirements, and the materials for forming them can be adjusted accordingly. Typically, plastic bottles require significant structural strength to allow them to be transported and stacked while protecting their liquid contents. Petroleum-derived polymers have been pre-eminently suitable for meeting such performance requirements. However, when these materials are made from petroleum-derived polymers, they impose significant burdens on the environment when fabricated and when discarded regardless of their originally intended use, because the petroleum-derived polymers render these materials long-lasting and resistant to disposal.

Composite NCE-containing materials can be engineered to address the performance needs of specific containers (such as a balance of flexibility, strength, and light weight), and furthermore to afford programmable decomposition. For example, to replace PVC for clamshell style packaging and for stiff boxes that have high rigidity, a composite NCE-containing material can be provided having a higher concentration of NCE reinforcement in the bio-based matrix. As another example, a substitute for the PET used for more flexible food product containers can comprise a composite NCE-containing material having a lower concentration of NFC reinforcement and higher plasticizer content. Methods for forming composite NCE-containing materials into containers and packaging materials include those familiar in the industry, such as (without limitation) thermoforming, vacuum forming, injection molding, extrusion and the like.

In embodiments, composite matrices can be produced from biodegradable existing matrices having combinations of specialized properties, such as advantageous mechanical properties and barrier properties. As an example, packaging materials can be formed from natural polymeric existing matrices as described previously, such as starch or derivatized cellulose (cellulose ethers or cellulose acetate), with barrier-producing materials optionally added, and with reinforcement provided by the redispersed NCEs. In embodiments, small NCE particles, for example shaped as fibers or bunched-up balls of longer reinforced NCE fibers, can be incorporated into the overall packaging material matrix for increased shock absorbency. NCE strands for this purpose can have intrinsic hydrophobicity, and optionally can be treated with materials to improve their oil and grease resistance. Overall, these bio-based existing matrices incorporating the redispersed NCE reinforcements (such as NCE fibers and/or NCE-reinforced polymer fibers) can be used for many packaging applications, including in packing peanuts, bladders, cardboard boxes, etc.

Packaging in general has a requirement for use-appropriate OGWR properties. A package or container intended for use with food products must contain any food-related fluids within the enclosure and must protect the contents from exposure to outside moisture, grease, and oil. The package or container must also remain structurally intact even if it encounters moisture, grease, or oil. The OGWR attributes of the package or container thus contributes to its structural stability by preventing the oil, grease, or water from impairing its strength or resilience. Barrier-producing formulations can also be used to produce OGWR properties in simple NCE-based materials and in composite NCE-containing materials used as packaging or containers.

For example, an OGR or WVR pouch, pod, or other packaging article formed from NCEs as described herein can serve as a container for condiments, dressings, or other liquid or gelatinous food substances, allowing the consumer to open the package and dispense the food substance as desired. Such packaging can conveniently contain and dispense aqueous or oil-based food substances like soy sauce, ketchup, mustard, mayonnaise, salad dressings, dairy products, and the like, thereby reducing the plastic waste associated with conventional packaging for such food substances.

An exemplary formulation to produce containers for non-oxygen sensitive substances (e.g., salt/pepper) can include the following ingredients (by weight, based on a total formulation weight of 100 g):
Methyl cellulose (MC): 85.5 g
Xylitol: 4.5 g
NCE: 10 g

An exemplary formulation to produce containers for oxygen-sensitive materials (e.g., see-through films for meat trays) can include the following ingredients (by weight, based on a total formulation weight of 100 g):
Polyvinyl alcohol (PVA): 23.75 g
Polyvinyl acetate (PVAc): 23.75 g
Methyl cellulose (MC): 42.75 g
Maltitol: 4.75 g
NCE: 5 g

An exemplary formulation to produce a water-resistant barrier, to be mixed into a slurry to be molded and thermoformed (by weight, based on a total formulation weight of 1000 dry g):
0.4 wt % aqueous pulp slurry: 8325 g (33.33 g dry wt)
Redispersible NCEs: 7.9175 g (NCE) and 23.7525 g (MC)
Rosin: 35 g (in Ethanol: 50 g)

An exemplary formulation to produce an oil, grease, and water-resistant barrier, to be mixed in or used as a coating (by weight, based on a total formulation weight of 100 g)
Cellulose acetate butyrate (CAB): 10 g
Rosin: 10 g
Acetone: 79 g
Plasticizer (for example, but not limited to triacetin, triethyl citrate, acetyl triethyl citrate, tributyl citrate): 1 g

An exemplary formulation for such a hydrophobic coating includes the following ingredients combined to form a solution in acetone (by weight, based on a total formulation weight of 100 g):
Cellulose Acetate (CA): 7 g
Ethanol: 14 g
Acetone: 71 g
Gum Rosin (GR): 7 g
Plasticizer (triacetin, triethyl citrate, or acetyl triethyl citrate): 1 g

Adding a barrier-producing formulation for OGWR purposes is especially useful in preparing versatile simple NCE-based materials: their mechanical properties are mainly provided by the simple NCE-based matrix itself, and this matrix, especially if pulp-dominant, is vulnerable to oil and grease and water penetration. Adding a barrier-producing formulation to such a simple NCE-based material can provide essential oil, grease, or water resistance, and can thus protect the contents from such incursions and can further protect the integrity of the material itself or packaging or containers made therefrom.

iv. Thin Films and Sheets

As an example, thin films and sheets used as wrappers or containers (such as stretch wraps, plastic bags, garbage bags, etc.) have a requirement for flexibility, elasticity, oil and water resistance, and strength. Currently these are typically made from polyethylene. As a substitute, a bio-based composite NCE-containing matrix can be produced, using a cellulosic polymer as the matrix-forming element in the existing matrix, and modifying this matrix or the final composite NCE-containing matrix to produce the desired elasticity. Potential cellulose derivatives include, without limitation, CMC (carboxymethyl cellulose), CMCNa (sodium carboxymethyl cellulose salt), CA (cellulose acetate), CDA (Cellulose diacetate), cellulose triacetate (CTA), CAB (cellulose acetate butyrate), CAPh (cellulose acetate phthalate), CAP (cellulose acetate propionate), EC (ethyl cellulose), HEC (hydroxyethyl cellulose), EHEC (ethyl hydroxyethyl cellulose), HPC (hydroxypropyl cellulose), HPMC (hydroxypropyl methylcellulose), HPMCP (hydroxypropyl methylcellulose phthalate), HPMCAS (hydroxypropyl methylcellulose acetate)). In order to achieve high elasticity, large entanglements of polymer chains can be produced in the existing matrix. Incorporating long chain crosslinkers to the natural polymer backbone through esterification can form a highly entangled and linked structure to provide the desired elasticity. For example, any mono or dicarboxylic acid (for example, but not limited to sebacic acid) can be cross-linked to the cellulosic polymer (e.g., cellulose diacetate) in the presence of an acid catalyst. The existing matrix thus prepared can be combined with the redispersed NFCs to form the composite NCE-containing matrix having adequate strength and elasticity. Other ingredients can be included in the existing matrix or the composite NCE-containing matrix to form the final composite NCE-containing material that can be used to form specified articles of manufacture using current industry methods.

Composite films or sheets formed from composite NCE-containing materials can be transparent or translucent as desired, with superior mechanical properties such as tear resistance, along with biodegradability. By contrast, conventional transparent or translucent films and sheets, such as are used for Ziplock bags, garbage bags, grocery bags, and the like, are typically formed from polyolefins such as polyethylene and polypropylene, which are petroleum-derived and slow to degrade. In embodiments, films and sheets formed by incorporating NCEs as described herein can be used for a multitude of other packaging applications where strength is desirable, to provide a biodegradable alternative to conventional polyolefin-based packaging materials.

A film or sheet having barrier properties such as OGWR properties provides important advantages when employed in commercial contexts. For example, the film or sheet thus can be employed as a wrapper or packaging having optimized resistance to oils and greases and/or optimized resistance to water or water vapor, to be used as a wrapper or packaging for delicate products. In embodiments, the film or sheet can be further tuned to improve oil resistance when encountering oils or oil suspensions, to optimize water resistance when encountering aqueous solutions or suspensions, to add strength, or to reduce gas permeability to produce more hermetic packaging properties. In embodiments, the composite NCE-containing materials with OGWR properties as disclosed herein can be modified by adding additional polymers or particles to the matrix material (e.g., PVA, PVOH, hydroxyethyl butyrate, exfoliated clay, and the like), to improve their hermetic properties.

For example, films or sheets with OGWR properties that are formed from composite NCE-containing materials can be used as components of or entire containers for liquids such as milk (e.g., shelf-stable milk cartons), to be sterilizable by techniques such as ultraviolet sterilization and other methods familiar to artisans of ordinary skill. In embodiments, such films or sheets can be transparent or translucent, with superior mechanical properties such as tear resistance or rigidity, offering a viable alternative to conventional packaging and hermetic films made from polyolefins.

As another example, films and sheets with OGWR properties that are formed from composite NCE-containing materials can be used as wrappers for food products. The existing matrix contributing to the composite NCE-containing materials used for these purposes can comprise conventional biodegradable, naturally derived polymers such as cellulose ethers, cellulose esters, starch ethers, starch esters, polyvinyl alcohol, hydroxyethyl butyrate, or any combination thereof. In these composite NCE-containing materials, the NCEs can contribute improved mechanical strength, rigidity and tear resistance to the material, which can be improved by inclusion of dispersant additives in the material. OGWR properties in the film or sheet can be produced by including a barrier-producing formulation having oleophobic and/or hydrophobic properties. In embodiments, the additive NCEs can be prepared to provide OGWR properties to the composite NCE-containing material, for example if these fibers are coated with films that produce these properties. With appropriate plasticizers, cellulose acetate or other hydrophobic, stretchy materials, can be added to impart elasticity onto the coated fibers, or can be incorporated into the polymer matrix to provide flexibility and stretchiness for the products. For products that are intended to be gas-impermeable, polyvinyl alcohol or copolymers of polyvinyl acetate/polyvinyl alcohol can be employed.

In more detail, a composite NCE-containing film or sheet can be prepared from an existing matrix comprising biodegradable materials such as cellulose ethers, cellulose esters, starch ethers, starch esters, polyvinyl alcohol, hydroxyethyl butyrate, polyvinyl acetate, or any combination thereof; additives can then be provided to produce the specific properties for a particular commercial need. As previously mentioned, OWGR properties are especially advantageous; a number of additives, as described above, can act as barrier-producing formulations to produce these properties. Other additives can be included in the composite NCE-containing material to produce other properties. For example, a film or sheet requiring gas-barrier properties can be made from a composite NCE-containing material that includes polyvinyl alcohol, polyvinyl acetate, copolymers thereof, or blends thereof.

The proportions of the ingredients in the composite NCE-containing matrix and composite NCE-containing materials can also be adjusted to improve certain properties. In embodiments, NCEs can be added at concentrations ranging from 1 wt % to 10 wt % to improve mechanical strength. In embodiments, an existing matrix can be prepared to augment physical integrity of the resultant composite NCE-containing matrix by using polymers selected for physical integrity and selecting high molecular weight versions thereof (for example, in molecular weight ranges from tens of thousands g/mol to millions g/mol, such as from a hundred thousand g/mol to millions g/mol). Plasticizers can be incorporated at concentrations ranging from, for example, about 1 wt % to about 50 wt %, or about 1 wt % to about 10 wt %, or about 5% to about 15%, to impart flexibility. Useful plasticizers can include, but are not limited to 1,2-propanediaol, xylitol, erythritol, maltitol, and mannitol, or fatty acids such as caprylic acid, caproic acid, or the like. Fatty acids used as plasticizers may be beneficial in a barrier application due to its hydrophobic nature. For large-scale processing, the full formulation (including redispersed NCEs, existing matrix or matrices, plasticizers, barrier-producing formulations, and other desired additives) can be mixed in a large tank and pumped to an extruder with a slot die. Extruded sheets may then be pressed and/or perforated with rollers. After drying (heated rollers or ovens) the pressed sheets can be collected into rolls or further shaped into bags or sachets.

v. Hollow Cylinders for Flexible Tubing Such as Drinking Straws

An application combining the features of biodegradability, strength, and barrier properties is the use of NCE materials to form a hollow cylinder that can be used to form a flexible tube, for example for use as a biodegradable drinking straw. Because straws are intended to be used with a variety of liquids, including alcohol, fats, acids, and the like, at various temperatures, and because straws require sufficient strength to resist deformation during normal use, there has been a tendency to use more durable plastics that are not biodegradable; biodegradable materials alone lack the liquid tolerance and strength to withstand the stresses that straws typically encounter. The use of NCE materials alone or in combination with other biodegradable materials can provide the necessary liquid tolerance and strength, while permitting the product to be biodegradable.

A simple NCE-based material as described above can be formed as a sheet and rolled into a hollow cylinder to act as a straw. Such a material can be pulp-dominant, so that it is formed economically with pulp or pulp-based bulking agents as a major component, in combination with the simple NCE-based matrix. Barrier-producing formulations are advantageous for providing the hydrophobicity or oleophobicity that is required by the anticipated end-use for the hollow cylinder, such as a drinking straw. As an example, bagasse or other fibrous agricultural waste products can be a source of NCEs that are redispersed according to the methods disclosed herein; such NCEs can then be mixed into a formulation comprising CA, rosin, and plasticizer to produce a composite NCE-containing material that can be extrudable to form drinking straws.

In other embodiments, a composite NCE-containing material can be formed that has the desirable OGWR properties, for example using a cellulose-based material such as methylcellulose for an existing matrix in combination with additive NCEs. In such a composite, cellulose acetate or other materials can be selected to produce hydrophobicity. For example, certain biodegradable LCST polymers or hydrophobic cellulosic polymers, such as CA or CAB, or other materials like polyvinyl alcohol or copolymers thereof such as polyvinyl acetate/polyvinyl alcohol, lipids, waxes, hydrophobic starch, fatty acids, or any other similar hydrophobic polymers can be included in the composite NCE-containing material to increase its hydrophobicity.

In embodiments, composite NCE-containing materials having OGWR properties can be mixed into an aqueous vehicle to produce a viscous mixture that can then be formed as a sheet or extruded as a hollow cylinder. Reinforcing materials such as spun hydrogel fibers can be added to the composite to improve strength and flexibility. For embodiments having OGWR properties, the ratio of OGR or WVR ingredients to NCEs can be from about 1:1 to about 12:1, or between about 3:1 to about 9:1. In another embodiment, a 2-3% suspension of NCEs can be mixed with a MC or other cellulosic-containing suspension. In embodiments, the NCE formulation can comprise CMFs as well as CNFs, or can comprise more CMFs than CNFs, or can consist essentially of CMFs, with the CMF to CNF ratio being adjusted to optimize the strength of the final formulation. In embodiments, regular pulp can be used in addition to or instead of derivatized cellulose in the mixture. Eliminating or decreasing the amount of the glycerol or other plasticizer used in the formulation can improve the stiffness of the straw product.

### EXAMPLES

### Example 1: Producing Redispersible NCE Sheets

Redispersible NCE sheets were produced by combining drying/dispersal additive with an NCE slurry and then drying it at elevated temperature in an oven. There are various combinations and multiple ratios of additives that can be used to create sheets of dried redispersible NCEs. For this specific example the LCST polymer hydroxypropyl methyl cellulose (HPMC) was used as the dispersal additive in combination with nanofibrillated cellulose (NFC) with a ratio of 5:1 NFC:HPMC. Ingredients were combined in a water solution consisting of 1.25 wt % NFC.

TABLE 3
Ingredients for creating redispersible NFC.

| 3 wt % NFC | Water | HPMC |
|---|---|---|
| 41.67 g (1.25 g dry) | 58.08 | 0.25 g |

First, 0.25 g of HPMC was added to 58.08 g of water in a beaker while stirring at a medium-high speed for about 15 minutes, following which the stir speed was decreased to its lowest setting, with mixing continued until all bubbles on the surface dissipated. After removing the beaker from the stir plate, 41.67 g of 3 wt % L NFC (1.25 g of dry weight NFC) was added. These ingredients were then mixed using an overhead stirrer at 250 rpm for 15 minutes. The fully mixed sample was then scooped onto a silicone mat and spread across the mat evenly, using a doctor blade set to 1.5 mm thickness. The mat with the sample on it was placed in an oven and dried at 60° C. until the sample was fully dried (about 2 hours). The dried sheet was slowly removed from the silicone mat. As a result of these procedures, the previously non-dispersible NFCs were modified with drying/dispersal additives so that they could be redispersed when combined with water. A dried sheet containing such redispersible NFCs was produced by these procedures.

### Example 2: Formulation and Manufacture of Composite NCE-Containing Transaction Card Sheets

Materials used in this Example can include:
Cellulose acetate butyrate (Sigma Aldrich)
Gum rosin (Sigma Aldrich)
Calcium carbonate (Sigma Aldrich)
Stearic Acid (Sigma Aldrich)
Triacetin (Sigma Aldrich)
Triethyl 2-acetylcitrate (Sigma Aldrich)
Hydroxymethyl propyl cellulose: Sigma Aldrich
Acetone (McMaster Carr)
Capryl glucoside (Berkley Green)

Equipment used in this Example can include:
Corning stir plate
ONiLAB overhead stirrer
CRUSHANUG Ultimate Design 5-Ton Hydraulic Heat Press Machine with Dual 3×5 inch Heated Plates
Dia Vac pump
Binder forced convection oven

This experiment tested initial formulations for producing a credit card with the structure of a composite NCE-containing material, wherein the composite NCE-containing material comprised a matrix containing redispersed NCEs. There were three main stages to this process: formulating the matrix, addition of the reinforcement, and heat press manufacture.

Formulating the matrix: An acetone solution comprising of 12 wt % matrix ingredients was formed by adding in each of the desired components one by one into a beaker of acetone while the beaker mixed on a magnetic stir bar. Matrix ingredients were added in a designated order, allowing enough time for the mixture to homogenize before adding in the next component. Subsequently, CAB, CA, or a combination of the two were added in and stirred until no clumps remained (˜30 minutes to 1 hour). Finally, but optionally, the plasticizer was added into the mixture and stirred for at least 15 minutes to obtain a homogeneous mixture.

The following ingredients were used to create three different matrices. Ingredients were listed in the order in which they were added to the beaker of acetone. Specific amounts of each component used are outlined in Table 1 below.
Matrix 1: Rosin, capryl glucoside (CG), CAB, TEA
Matrix 2: Stearic acid, CC, CAB, TEA
Matrix 3: Rosin, stearic acid, CC, CAB, triacetin

TABLE 1
Recipes for Matrices 1, 2, and 3

| Matrix | CAB | Rosin | Plasticizer | Stearic | CC | CG | Acetone |
|---|---|---|---|---|---|---|---|
| 1 | 73 g | 20.4 | 5.6 | 0 g | 0 g | 1 g | 733 g |
| 2 | 67 g | 0 g | 8.3 | 15 g | 10 g | 0 g | 733 g |
| 3 | 67 g | 17 | 2 | 8 g | 6 | 0 g | 733 g |

The following ingredients were used to create three different matrices. Ingredients are listed in the order in which they were added to the beaker of acetone. Specific amounts of each component used are outlined in Table 2 below.

Addition of the Redispersed NCE-containing Formulation: Sheets of redispersible NCEs prepared as described in Example 1 were added into a large beaker and mixed vigorously with an overhead stirrer for 30 minutes. In these experiments we used equal amounts of dry NCE to CAB. Acetone was added in with the fully dispersed fibers and thoroughly mixed with a stir rod. The amount of acetone included was 40% of the weight of the redispersed NFC solution. Once the mixture was homogenized, the reinforcement was ready to be added to the matrix. The table below (Table 2) lists the amount of NCE and acetone required for addition to Matrices 1, 2, and 3.

TABLE 2

| | Dispersible | |
|---|---|---|
| Matrix | NCE Sheet | Acetone |
| 1 | 73 g | 29.2 g |
| 2 | 67 g | 26.8 g |
| 3 | 67 g | 26.8 g |

The redispersed NCE acetone mixture was then added into the beaker containing the matrix ingredients and mixed on the overhead stirrer using a turbine stirrer for 10 minutes until homogeneous.

Heat Press Manufacture: The final step in this experiment involved using a heat press to form the newly created composite mixture into a thin structure, such as could be employed for transaction cards. Before the material was inserted into the heat press, excess acetone was removed using a sieve and vacuum filtration pump. The filtration system consisted of a vacuum pump and two Erlenmeyer flasks that were all connected with tubing. A sieve was taped to a funnel and connected to the first flask with tubing. The composite material was then placed in the sieve and the vacuum was turned on. Liquid was pulled from the composite material through the sieve, then the funnel; the liquid then passed through the tubing to be collected in the first Erlenmeyer flask. Once no more liquid was being pulled through the funnel, this step was completed. The composite NCE-containing material was a solid after this excess liquid was removed. It was not completely dry, a desirable state for holding the material together until it had been pressed by the heat press.

The heat press was turned on and set to 110° C. Five grams of the composite NCE-containing material was pressed by hand into a flat rectangular shape (˜3 mm thick) and placed in between two pieces of silicone mat. Once the press had been heated, the silicone mats containing the composite material were placed on the bottom plate of the press. The top plate was then brought down to start heating the material by slightly touching the top silicone mat. After two minutes the plate was brought down a little bit further to apply some pressure to it. These processes were repeated until enough pressure had been applied to press the material into the desired thickness, for example, a 1 mm thick sheet that was able to be further cut into shapes that would be useful for transaction cards such as credit cards.

### Example 3: Formulation and Manufacture of Composite NCE-Containing Transaction Card Sheets

Formulating the matrix: An acetone solution comprising of 10 wt % matrix ingredients was formed by adding in each of the desired components one by one into a beaker of acetone while the beaker was mixed on a magnetic stir bar. Matrix ingredients were added in a designated order, allowing enough time for the mixture to homogenize before adding in the next component. Rosin was first added into the acetone, followed by CAB or CA, and then finally a plasticizer. Mixing continued until the solution was homogeneous before adding further ingredients.

Sheets of redispersible NCEs prepared as described in Example 1 were added into a large beaker and mixed vigorously with an overhead stirrer for 30 minutes. The amount of NCE used depended on the desired end stiffness of the material. Cards were produced with a higher NFC loading around 28% and lower loadings around 17%. Pulp was then added to the redispersed NCE solution and mixed. Acetone was then added to the solution.

Acetone was added in with the fully dispersed fibers and thoroughly mixed with a stir rod. The amount of acetone included was 40% of the weight of the redispersed NFC solution. Once the mixture was homogenized, the reinforcement was ready to be added to the matrix at a 23× loading relative to solid fibers (1:23 pulp+NCE:acetone). Addition of the acetone aided in addition of the hydrophilic cellulose fibers into a hydrophobic solution. It was ideal to use low solid contents of pulp and redispersed NCEs in water to help aid in homogeneous blending. After acetone was added, the solution was further mixed at high shear with an overhead stirrer. Capryl glucoside was also added to this solution to help bridge the polar and nonpolar components upon mixing in the next step. After both the matrix and the reinforcement had been thoroughly mixed, the two solutions were ready to be combined. The reinforcement solution was slowly added into the matrix solution that was being vigorously mixed under high shear conditions.

The table below (Table 3) lists exemplary formulations of cards produced with CAB. These formulation ratios can also be applied to samples produced via extrusion.

TABLE 3

| Hydrophilic Solution | | | Hydrophobic Solution | | |
|---|---|---|---|---|---|
| Pulp | NFC | Capryl | Rosin | CAB | TEA |
| 91.7 | 275.2 | 22.9 | 156 | 412.8 | 41.3 |
| 76.2 | 228.7 | 19.1 | 172.8 | 457.4 | 45.7 |
| 57 | 170.9 | 14.2 | 193.7 | 512.8 | 51.3 |

Heat Press Manufacture: The final step in this experiment involved using a heat press to form the newly created composite mixture into a thin structure, such as could be employed for transaction cards or other rigid packaging applications. Prior to heat pressing the material, some solvent was evaporated by heating the material uniformly in an oven at 50-70° C. for 5-30 minutes. The heat press was turned on and set to 120° C. A rectangle mold was placed on the press on top of a silicone mat and filled with the composite material. A mesh net and second silicone mat were placed on top of the mold. The top plate was then brought down to start heating the material by slightly touching the top silicone mat. After two minutes the plate was brought down a little bit further to apply more pressure to it. These processes were repeated until enough pressure had been applied to press the material into the desired thickness and evaporate the solvent, for example, a 1 mm thick sheet that was able to be further cut into shapes that would be useful for transaction cards such as credit cards.

While this invention has been particularly shown and described with references to preferred embodiments thereof, it will be understood by those skilled in the art that various changes in form and details may be made therein without departing from the scope of the invention encompassed by the appended claims. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference. The relevant teachings of all patents, published applications and references cited herein are incorporated by reference in their entirety.

1. A simple NCE-based material comprising a simple NCE-based matrix, wherein the simple NCE-based matrix comprises a population of redispersible NCEs treated with a drying/dispersal additive comprising a lower critical solution temperature (LCST) polymer;
wherein the simple NCE-based matrix provides an architectural framework for the simple NCE-based material; and
wherein the simple NCE-based material further comprises a barrier formulation.

2. The simple, NCE-based material of claim 1, wherein the barrier formulation comprises a substance selected from the group consisting of cellulosic polymers, lipids, proteins, fillers, fatty acids, a resin acid, and combination of resin acids.

3. The simple, NCE-based material of claim 2, wherein the barrier formulation comprises a resin acid or combination of resin acids.

4. The simple, NCE-based material of claim 1, wherein the barrier formulation comprises an oleophobic substance selected from the group consisting of MC, HPMC, CMC, NaCMC, CA, CAB, chitosan, rosin, lignin, and a vegetable protein.

5. The simple, NCE-based material of claim 1, wherein the barrier formulation comprises a hydrophobic substance selected from the group consisting of MC, CA, CAB, chitosan, rosin, hydrophobized starch, lignin, and a vegetable protein.

6. The simple NCE-based material of claim 1, further comprising one or more additive substances selected from the group consisting of a bulking agent, a reinforcement agent, or an appearance-modifying agent, or a combination thereof.

7. The simple NCE-based material of claim 6, wherein the one or more additive substances is a bulking agent.

8. The simple NCE-based material of claim 7, wherein the bulking agent comprises pulp or a pulp-based substance.

9. The simple NCE-based material of claim 8, wherein the simple NCE-based matrix is pulp-dominant.

10. The simple NCE-based material of claim 7, wherein the bulking agent comprises filler particles.

11. The simple NCE-based material of claim 10, wherein the filler particles comprise plant-derived organic materials.

12. The simple NCE-based material of claim 6, wherein the one or more additive substances is a reinforcement agent, and the reinforcement agent comprises an additional amount of NCEs.

13. A plastic substrate comprising the simple NCE-based material of claim 1.

14. An article of manufacture, comprising the plastic substrate of claim 13 shaped into a formed article.

15. The article of manufacture of claim 14, wherein the formed article is a container.

16. The article of manufacture of claim 15, wherein the container is a food product container.

17. A method of manufacturing a plastic article comprising a simple NCE-based material in a pliable state, comprising:
a. producing a simple NCE-based material comprising redispersible NC elements, wherein the simple NCE-based material is produced by the substeps of:
i. providing an initial suspension comprising NC elements suspended in a fluid medium;
ii. combining a drying/dispersal additive with the initial suspension to form a pliable suspension of redispersible NCEs; and
iii. adding one or more additive substances to the pliable suspension of redispersible NCEs while retaining pliability thereof, thereby forming the simple NCE-based material in a pliable state;
b. forming or shaping the simple NCE-based material in the pliable state into a desired configuration, thereby manufacturing the plastic article.

18. The method of claim 17, wherein the one or more additive substances are selected from the group consisting of reinforcement agents, barrier formulations, and bulking agents, and a combination thereof.

19. The method of manufacturing of claim 17, wherein the step of forming or shaping comprises extrusion.

20. A composite NCE-containing material comprising a composite NCE-containing matrix,
wherein the composite NCE-containing matrix comprises a population of redispersible NCEs treated with a drying/dispersal additive comprising a lower critical solution temperature (LCST) polymer, and an existing matrix;
wherein the redispersible NCEs are integrated into the existing matrix, and wherein the existing matrix provides an architectural framework for the composite NCE-containing material; and
wherein the composite NCE-containing material further comprises a barrier formulation.

21-35. (canceled)
